(19) United States
(12) Patent Application Publication
(10) Pub. No.: US 2005/0116967 A1
(43) Pub. Date: Jun. 2, 2005

(54) Driver apparatus, display device and control method

(75) Inventors: Tomoyuki Shirasaki, Higashiyamato-shi (JP); Tsuyoshi Ozaki, Fussa-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd, Tokyo (JP)

(21) Appl. No.: 10/998,310

(22) Filed: Nov. 26, 2004

(30) Foreign Application Priority Data
Nov. 28, 2003 (JP) 2003-399677

(51) Int. Cl. G09G 5/10

(52) U.S. Cl. 345/690

(57) ABSTRACT

A driver apparatus which drives each display pixel of a display panel having a plurality of display pixels equipped with current control type light emitting devices comprising a signal voltage generation circuit which generates a signal voltage having a voltage value corresponding to the display data and a voltage-current conversion circuit which supplies the display pixels by converting the signal voltage into a gradation current comprising a conversion circuit section which generates a signal current having a current value corresponding to the signal voltage. The conversion circuit section comprises a compensation circuit having a switching element constituted by a Field-Effect type Thin-Film Transistor which uses for example amorphous silicon and compensates component characteristic fluctuation in the switching element.

### CROSS-REFERENCE TO RELATED APPLICATION

This application is based upon and claims the benefit of priority from the prior Japanese Patent Application No. 2003-399677, filed Nov. 28, 2003, the entire contents of which is incorporated herein by reference.

### BACKGROUND OF THE INVENTION

1. Field of the Invention

The present invention relates to a driver apparatus, display device and associated drive control method, and more particularly relates to a driver apparatus applied to a display panel array comprising a plurality of display pixels with current control type light emitting devices for emitting light at a predetermined luminosity gradation by supplying current corresponding to the display data, a display device equipped with this driver apparatus and its drive control method.

2. Description of the Related Art

In recent years, as the next generation display device (display) following liquid crystal displays (LCD's) which at present are abundantly used as monitors and displays for personal computers and video equipment, Research and Development (R&D) toward full-scale utilization of luminous element type displays (display devices) comprising a display panel consisting of a two-dimensional array containing self-luminescence type optical elements such as organic electroluminescent devices (hereinafter denoted as “organic EL devices”), inorganic electroluminescent devices (hereinafter denoted as “inorganic EL devices”) or Light Emitting Diodes (LEDs), etc. is actively being developed.

Especially in a luminous element type display which applies an active-matrix drive method as compared with an LCD which provides a more rapid display response speed and there is no viewing angle dependency. As backlight is not needed like an LCD, this very predominant feature enhances the clarity of displayed images and makes even higher contrast and higher luminosity more practicable in the years ahead. Thus, the likelihood is inevitable of further miniaturized, low-powered and thin-shaped displays in the future.

FIG. 19 is an entire block diagram showing an outline configuration of a luminous element type display in conventional prior art.

An example of such a display, in summary and as shown in FIG. 19, comprises a display panel 110p array of display pixels EMp containing current control type light emitting devices near each intersecting point of scanning lines SL arranged in the direction of rows and data lines DL arranged in the direction of columns; a data driver 130p which generates gradation current Ipix corresponding to an image display signal (display data) and is supplied to each display pixel EMp via the data lines DL; and a scanning driver 120p which sequentially applies a scanning signal Vsel at predetermined timing and sets the display pixels EMp of specified rows in a selection state. Current based on the above-stated gradation current Ipix supplied to each display pixel EMp is provided to each light emitting device, light generation operation is performed by predetermined luminosity gradation corresponding to the display data and desired image information is displayed on the display panel 110p. In addition to the above-mentioned light emitting devices, the display pixels EMp comprise pixel driver circuits which consist of a plurality of switching elements for drive controlling the light generation state of these light emitting devices.

Here, as the drive method in the above-stated display, for example, a current application type method is realized in which a separate gradation current is generated containing a current value corresponding to the display data from the data driver to a plurality of display pixels; the display pixels of specified rows selected by the scanning driver are supplied; and an operation which causes the light emitting device of each display pixel to emit light by predetermined luminosity gradation corresponding to that current value is successively repeated in each row for one screen.

FIG. 20 is a circuit configuration diagram showing an example of a data driver in conventional prior art.

As an illustrative configuration of the data driver as applied to the above-mentioned current application type method of display, for example as shown in FIG. 20, comprises a constant current drive circuit (current driver) with a current mirror circuit composed of a Metal-Oxide Semiconductor (MOS) transistor TPr in which one end side (emitter) of the current path is connected to a power supply terminal TMp and the other end side (collector) is connected to a reference current input terminal TMr; and a plurality of MOS transistors TP1, TP2, . . . TPm in which each control terminal (base) is connected in parallel to the control terminal (base) of the above-mentioned MOS transistor TPr, along with one end side (emitter) of the current path connected in common to the above-mentioned power supply terminal TMp via a common power supply line Lp and the end side (collector) connected to separate output terminals OUT1, OUT2, . . . OUTm. In such a data driver, light generation operation of the display pixels (light emitting devices) is performed by supplying collectively the gradation current IP1, IP2, . . . IPm having a constant current value which flows into the plurality of MOS transistors TP1, TP2, . . . TPm toward a plurality of display pixels which constitute the display panel (not shown) via separate output terminals OUT1, OUT2, . . . OUTm (or via an output circuit (not shown)) corresponding to a reference current Ir which flows into the MOS transistor TPr.

However, when the light emitting devices in the display pixels consist of organic EL devices, the current necessary at times of minimum gradation constitutes an extremely minute current value. For example, as the display size shown in Table 1, a 1.9 inch diagonal display panel was set up with the stated design specifications, pixel count, pixel array, dot size, number of gradations, etc. and the display pixels (organic EL devices) were made to emit light for each color of blue, green and red in the display panel. The result of having performed simulations such as the current characteristic, etc. as shown in Table 2 also set to any of the luminous colors of blue, green and red, gradation current having a current value in the order of a few micro-amps (μA) (maximum value of 3.05 μA when performing red luminescence) in maximum luminosity gradation and having a current value in the order of a few tenths of a nano-amp (nA) (minimum value of 12.8 nA when performing green luminescence) in minimum luminosity gradation is needed. (Note: In Table 2, MSB denotes “Most Significant Bit” and LSB denotes “Least Significant Bit”)

TABLE 1

| | HORIZONTAL | VERTICAL |
|---|---|---|
| AVAILABLE DISPLAY AREA | 30.72 mm | 38.40 mm |
| PIXEL COUNT | 128 × RGB | 160 |
| PIXEL ARRAY | COLUMN | |
| DOT SIZE | 80 μm | 240 μm |

| | |
|---|---|
| MAXIMUM WHITE LUMINANCE | 400 nit |
| APERTURE RATE | 25% |
| NUMBER OF GRADATIONS | 64 |

TABLE 2

| | COLOR | | | | | | | |
|---|---|---|---|---|---|---|---|---|
| | CHROMA- | | LUMINOUS | LUMINANCE/ | MSB | | | LSB |
| | TICITY | | EFFICIENCY | DOTS | CURRENT/DOTS | CURRENT | EL VOLTAGE | CURRENT/DOTS |
| | x | y | cd/A | cd/m² | μA | RATIO | V | n A |
| BLUE (B) | 0.155 | 0.156 | 4.31 | 312 | 1.39 | 0.46 | 5.61 | 21.7 |
| GREEN (G) | 0.384 | 0.599 | 15.7 | 672 | 0.82 | 0.27 | 3.44 | 12.8 |
| RED (R) | 0.670 | 0.382 | 1.38 | 220 | 3.05 | 1.00 | 4.70 | 47.7 |

Here, the relationship of saturation current relative to a MOS transistor's channel shape (ratio of channel width versus channel length; W/L) can be verified when a data driver is constituted from a MOS transistor formed on a single-crystal silicon substrate.

FIG. 21 is a characteristic drawing showing the distinction of saturation current relative to an MOS transistor's channel shape.

Referring to FIG. 21, in order to generate gradation current within a current range (10 nA˜1 μA) necessary for light generation operation of up to 3.05 μA which is the current value of gradation current at the time of maximum luminosity gradation when performing red luminescence aside from 12.8 nA which is the current value of gradation current at the time of minimum luminosity gradation when performing green luminescence as mentioned above, generally a W/L=0.0009 is required as the channel shape and it is essential to control the voltage between gate-source of the MOS transistor by about Vgs=0.5V˜8V as a rule. For that reason, the aspect ratio (ratio of structural height to width) of the planar shape will consist of a noticeably elongated rectangle in one direction (lengthwise). The W/L value changes greatly because of processing accuracy variations in the manufacturing process of MOS transistors which tend to produce fluctuation in the operating characteristics. Thus, there is difficulty in generating gradation current which has an extremely minute current value in the order of a few tenths of a nano-amp (nA) with adequate precision. Additionally, the above-stated fundamental factors will ultimately limit circuit design downscaling and perpetuate inefficiency in planar circuit formation dimensions.

### SUMMARY OF THE INVENTION

The present invention features a display device comprising a driver apparatus which performs light generation control by a current specification method of the display pixels containing current control type light emitting devices. In particular, as the present invention will control the influence of processing accuracy fluctuations derived from the manufacturing process of functional elements, such as transistors, etc., equalization of the operating characteristics can be achieved. This is accomplished by being able to generate and output stable micro-current which is supplied to the display pixels with highly accurate precision. As a direct result, first-rate display image quality which remains stable over a long period of time and at low cost can be acquired.

The driver apparatus in the present invention for acquiring the above-mentioned effect comprises a signal voltage generation circuit which generates a signal voltage having a voltage value corresponding to the display data and a voltage-current conversion circuit containing at least one of a conversion circuit section which generates a signal current having a current value corresponding to the signal voltage which is generated by the signal voltage generation circuit and supplies the display pixels by converting the signal current into a gradation current.

Each display pixel comprises a current control type light emitting device which performs light generation operation by a luminosity gradation corresponding to the gradation current.

A conversion circuit section comprises a configuration that at least includes a switching element which generates the signal current with one end side of the switching element current path connected to a drive power supply having a predetermined voltage value and the other end side of the current path connected to the display pixels via the data lines and the signal voltage is applied to the switching element control terminal. The switching element is a Field-Effect type Thin-Film Transistor which uses amorphous silicon, or a Field-Effect type Thin-Film Transistor which uses polycrystalline silicon, or is a transistor composed of a semiconductor whose electron mobility is lower than 50 cm²/Vs.

A drive power supply voltage value is set as a different voltage value for each luminous color corresponding to a luminous color set as the display pixels.

A conversion circuit section comprises at least a compensation circuit which compensates component characteristic fluctuation in the switching element. The switching element is a Field-Effect type Thin-Film Transistor and the component characteristic is the Thin-Film Transistor threshold voltage characteristic.

A compensation circuit comprises at least a precharge circuit which applies a precharge voltage corresponding to the switching element threshold voltage to the switching element control terminal prior to applying the signal voltage to the switching element control terminal.

The conversion circuit section further comprises a reset circuit which applies a reset voltage to the display pixels prior to supplying the gradation current, a read-in circuit which applies the signal voltage to the control terminal of the switching element, and a write-in circuit which supplies the display pixels by converting the signal current into the gradation current that flows in the switching element current path based on the precharge voltage and a sum total voltage of the signal voltage.

A voltage-current conversion circuit of a plurality of the conversion circuit sections are connected in parallel and concurrently execute at least a read-in operation which applies the signal voltage by the read-in circuit of the switching element in the conversion circuit section to any one of the plurality of conversion circuit sections and a write-in operation which supplies the gradation current to the display pixels corresponding to the signal voltage applied to the switching element at previous timing by the write-in circuit in the other conversion circuit sections.

A display device in the present invention for acquiring the above-stated effect, a display data comprising a display panel which has a plurality of scanning lines and a plurality of data lines arranged in row and column directions, and a plurality of display pixels arranged in matrix form near each intersecting point of the plurality of scanning lines and the plurality of data lines; a scanning driver circuit which sequentially applies a scanning signal to each row of the display pixels in the display panel at predetermined timing for setting in a selection state; a signal voltage generation circuit which generates a signal voltage having a voltage value corresponding to the display data; a voltage-current conversion circuit containing at least one of a conversion circuit section which generates a signal current having a current value corresponding to the signal voltage which is generated by the signal voltage generation circuit and supplies the display pixels by converting the signal current into a gradation current.

The display panel comprises at least a pixel driver circuit which generates light generation drive current having a current value corresponding to the gradation current and a current control type light emitting device which performs light generation operation by a luminosity gradation corresponding to the gradation current. The pixel driver circuit is constituted by including a switching element which uses amorphous silicon.

The pixel driver circuit comprises at least a charge storage circuit which stores an electric charge accompanying the gradation current and a drive control circuit which generates the light generation drive current based on an electric charge stored in the charge storage circuit and supplies the light emitting devices. The display pixels are controlled so that an electric charge accompanying the gradation current is stored in the charge storage circuit in a selection period when each row of the display pixels is selected by the scanning driver circuit, and the light generation drive current generated by the drive control circuit is supplied to the light emitting devices in a non-selection period when each row of the display pixels is non-selected. The light emitting devices are set in a non-operational state during the selection period and set in an operational state during the non-selection period. Additionally, the light emitting devices are organic electroluminescent devices.

The voltage-current conversion circuit in one unit with the signal voltage generation circuit or formed in one unit with the display pixels on an insulating substrate constitutes the display panel.

The conversion circuit section at least includes a switching element which generates the signal current with one end side of the switching element current path connected to a drive power supply having a predetermined voltage value.

Each of the plurality of display pixels in the display panel are set as any luminous color of red, green, blue arranged in a predetermined order and the drive power supply voltage value is set as a different voltage value for each luminous color corresponding to a luminous color set as each of the display pixels.

The conversion circuit section comprises at least a compensation circuit which compensates component characteristic fluctuation in the switching element. The switching element is a Field-Effect type Thin-Film Transistor and the component characteristic is the Thin-Film Transistor threshold voltage characteristic.

The compensation circuit comprises at least a precharge circuit in which the preceding application of the signal voltage to the switching element control terminal applies a precharge voltage to the switching element control terminal corresponding to the switching element threshold voltage.

The conversion circuit section further comprises a reset circuit which applies a reset voltage to the data lines prior to supplying the gradation current, a read-in circuit which applies the signal voltage to the control terminal of the switching element, a write-in circuit which supplies the display pixels via the data lines by converting the signal current into the gradation current that flows in the switching element current path based on the precharge voltage and a sum total voltage of the signal voltage.

The voltage-current conversion circuit has a plurality of the conversion circuit sections connected in parallel for each of the data lines and concurrently execute at least a read-in operation which applies the signal voltage by the read-in circuit of the switching element in the conversion circuit sections to any one of the plurality of conversion circuit sections and a write-in operation which supplies the gradation current to the data lines corresponding to the signal voltage applied to the switching element at previous timing by the write-in circuit in the other conversion circuit sections.

In the present invention for acquiring the above-stated effect, a drive control method for a display device displays desired image information comprising a display panel having a plurality of display pixels arranged in matrix form near each intersecting point of a plurality of scanning lines and a plurality of data lines. The display pixels are driven at least by sequentially applying a scanning signal to each row of the display pixels in the display panel at predetermined timing for setting in a selection state generating a signal voltage having a voltage value corresponding to the display data. By applying the signal voltage to a switching element control terminal for use in voltage-current conversion, a signal current having a current value corresponding to the signal voltage flows in the switching element current path and the signal current is supplied as a gradation current via the data lines to the display pixels of rows set in the selection state.

The drive control method for the switching element includes a process step which compensates component characteristic fluctuation prior to applying the signal voltage to the switching element. The switching element is a Field-Effect type Thin-Film Transistor and the component characteristic is the Thin-Film Transistor threshold voltage characteristic.

The switching element process step which compensates component characteristic fluctuation includes a process step which at least applies a precharge voltage corresponding to the switching element threshold voltage to the switching element control terminal prior to applying the signal voltage to the switching element control terminal.

The process step which supplies the gradation current to the display pixels via the data lines includes process steps of applying a reset voltage to the data lines prior to supplying the gradation current, applying the signal voltage to the control terminal of the switching element and the signal current which flows in the switching element path is supplied to the display pixels via the data lines as the gradation current based on the precharge voltage and a sum total voltage of the signal voltage.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram of the first embodiment showing the entire configuration of the display device as applied to the drive apparatus related to the present invention;

FIG. 2 is an outline block diagram showing an example of the main section configuration of the display device related to the present invention;

FIG. 3 is a block diagram showing the outline configuration of the signal voltage generation circuit as applied to the display device related to the first embodiment;

FIG. 4 is a circuit configuration drawing showing an illustrative circuit example of a pixel driver circuit of the display pixels as applied to the display device related to the present invention;

FIGS. 5A and 5B are conceptual diagrams showing the display pixel drive control operation as applied to the display device related to the present invention;

FIG. 6 is a timing chart showing the display drive operation of the display device applied to the display pixels related to the illustrative example;

FIG. 7 is a characteristic drawing showing the distinction of saturation current relative to a Thin-Film Transistor which uses amorphous silicon;

FIG. 8 is an outline block diagram showing an example of the main section configuration in the second embodiment of the display device applied to the driver apparatus related to the present invention;

FIG. 9 is an outline block diagram showing an example of the main section in the third embodiment of the display device applied to the driver apparatus related to the present invention;

FIG. 10 is a timing chart showing the drive control operation in the voltage-current conversion circuit (switching circuit section) related to the third embodiment;

FIG. 11 is a conceptual diagram showing the process of the reset operation in the voltage-current conversion circuit (switching circuit section) related to the third embodiment;

FIG. 12 is a conceptual diagram showing the process of the precharge operation in the voltage-current conversion circuit (switching circuit section) related to the third embodiment;

FIG. 13 is a conceptual diagram showing the process of the threshold voltage adjustment operation in the voltage-current conversion circuit (switching circuit section) related to the third embodiment;

FIG. 14 is a conceptual diagram showing the process of the data read-in operation in the voltage-current conversion circuit (switching circuit section) related to the third embodiment;

FIG. 15 is a conceptual diagram showing the process of the data write-in operation in the voltage-current conversion circuit (switching circuit section) related to the third embodiment; FIG. 16 is an outline block diagram showing an example of the main section configuration in the fourth embodiment of the display device applied to the driver apparatus related to the present invention;

FIG. 17 is a timing chart showing the drive control operation in the voltage-current conversion circuit related to the fourth embodiment;

FIGS. 18A and 18B are outline block diagrams showing examples of the mounting configurations of the driver apparatus and display device related to the present invention;

FIG. 19 is an entire block diagram showing an outline configuration of a light emitting device type display in conventional prior art;

FIG. 20 is a circuit configuration diagram showing an example of a data driver in conventional prior art.

FIG. 21 is a characteristic drawing showing the distinction of saturation current relative to an MOS transistor's channel shape.

### DETAILED DESCRIPTION OF THE PREFERRED EMBODIMENTS

Hereinafter, the details of a driver apparatus and a display device together with its drive control method related to the present invention will be explained based on the embodiments shown in the drawings.

### First Embodiment

Initially, the first embodiment of a display device which can practicably apply the driver apparatus related to the present invention will be explained with reference to the drawings.

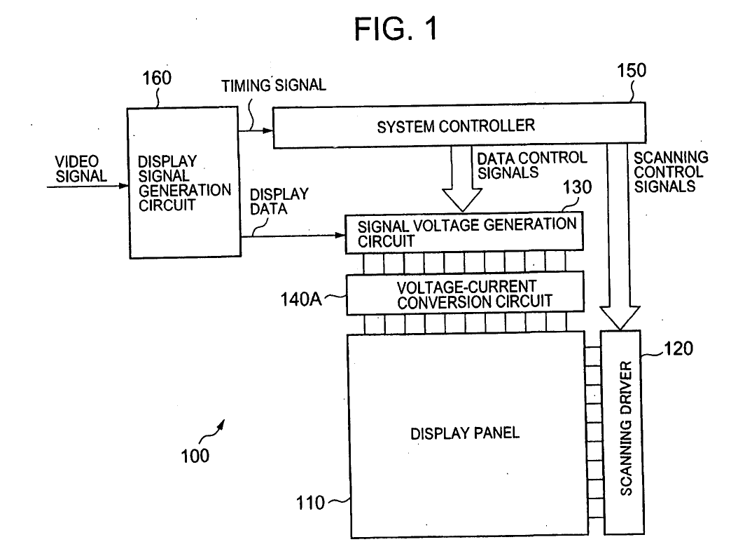

FIG. 1 is a block diagram of the first embodiment showing the entire configuration of the display device as applied to the drive apparatus related to the present invention.

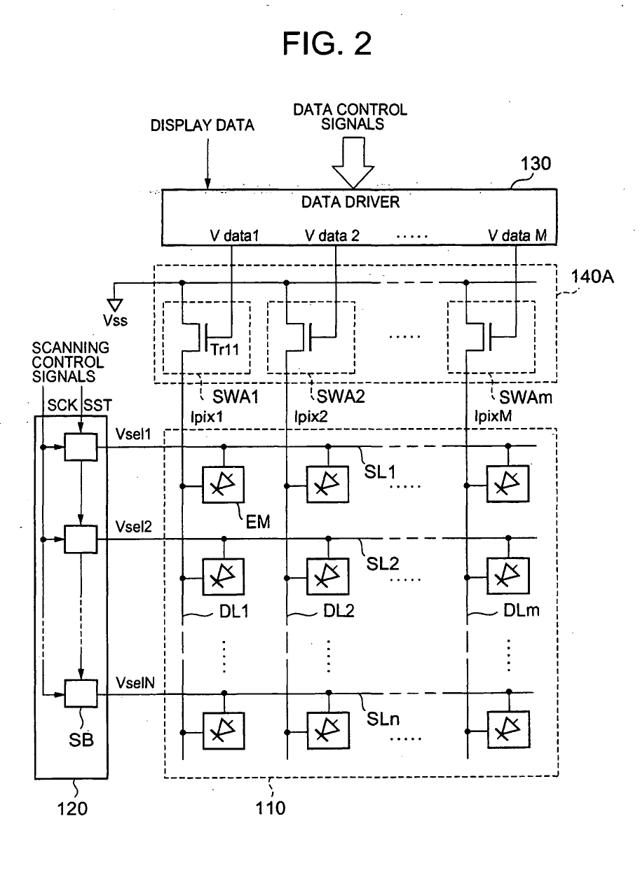

FIG. 2 is an outline block diagram showing an example of the main section configuration of the display device related to the present invention.

Here, with respect to any configuration equivalent of the structure illustrated in the conventional prior art described above, the same nomenclature is appended for explanation. In addition, pertaining to the display pixels which constitute the display panel in the following explanation, although the configuration can be equipped with organic EL devices as the light emitting devices is illustrated, the display device related to the present invention is not limited to this. As long as each display pixel comprises at least a current control type light emitting device which performs light generation operation (also commonly referred to as “luminescent operation”) by predetermined luminosity gradation corresponding to a current value of current supplied, a Light Emitting Diode (LED), etc. for example may be applied as the light emitting device.

As shown in FIG. 1 and FIG. 2, a display device 100 related to the first embodiment, in summary, has a configuration comprising a display panel 110, a scanning driver 120 (scanning driver circuit), a signal voltage generation circuit 130, a voltage-current conversion circuit 140A, a system controller 150 and a display signal generation circuit 160. The display panel 110 contains a plurality of display pixels EM arranged near each intersecting point of a plurality of scanning lines SL1, SL2, . . . SLn (for convenience, referred to as “n” lines. Hereinafter denoted generically and also described as “scanning lines SL”) arranged to intersect orthogonally with each other relative a plurality of data lines DL1, DL2, . . . DLm (For convenience, referred to as “m” lines. Hereinafter denoted generically and also described as “data lines DL”). The scanning driver 120 (scanning driver circuit) sets (scans) the display pixels EM group for each row in a selection state by connecting to each of the scanning lines SL of the display panel 110 and applying the scanning signal Vsel1, Vsel2, . . . VselN (hereinafter denoted generically and also described as “scanning signal vsel”) of a high-level sequentially at predetermined timing to each of the scanning lines SL. The signal voltage generation circuit 130 generates a signal voltage Vdata1, Vdata2, . . . VdataM (hereinafter denoted generically and also described as “signal voltage Vdata”) based on the display data provided from a display signal generation circuit 160 described later. The voltage-current conversion circuit 140A which is connected to each data line DL of the display panel 110 generates a gradation current Ipix1, Ipix2, . . . IpixM (hereinafter denoted generically and also described as “gradation current Ipix”) which is supplied to each of the data lines DL based on the signal voltage Vdata generated by the signal voltage generation circuit 130. The system controller 150 at least generates and outputs scanning control signals and data control signals for the purpose of controlling the operational state of the scanning driver 120 and the signal voltage generation circuit 130. The display signal generation circuit 160 extracts or generates timing signals (system clock, etc.) for displaying image information based on the present display data which is supplied to the system controller 150.

Hereinafter each of the above-described configurations will be explained.

(Display Panel)

The display panel 110 applicable to the display device 100 related to the first embodiment, for example as shown in FIG. 2, comprises at least the scanning lines SL and the data lines DL arranged to intersect orthogonally (composed of right angles) with each other and has a configuration of the display pixels EM comprising pixel driver circuits described later and organic EL devices (current control type light emitting devices) connected at least to each intersection of the scanning lines SL and the data lines DL. Furthermore, the display panel comprising the organic EL devices described later, in addition to the scanning lines SL and the data lines DL, has a configuration arranged with a voltage line VL (not shown) in parallel to each of the scanning lines SL. These will be described in detail later.

(Scanning Driver)

The scanning driver 120 sets the display pixels EM group for each row in a selection state by applying sequentially the scanning signal Vsel of a high-level to each of the scanning lines SL based on scanning control signals supplied from the system controller 150 and controls write-in of the gradation current Ipix to the display pixels EM (pixel driver circuits described later) which is supplied via each of the data lines DL based on the signal voltage Vdata generated by the signal voltage generation circuit 130 described later.

Specifically, for example as shown in FIG. 2, the scanning driver 120 comprises a shift block SB containing a shift register and a buffer with plural steps corresponding to each of the scanning lines SL. While a shift signal shifts sequentially from the upper part to the lower part of the display panel 110 by the shift register, a generated shift signal is converted into a predetermined voltage level (high-level) via the buffer and outputted to each of the scanning lines SL as the scanning signal Vsel (Vsel18˜VselN) based on the scanning control signals (a scanning start signal SST, a scanning clock signal SCK, etc.) supplied from the system controller 150 described later.

(Signal Voltage Generation Circuit)

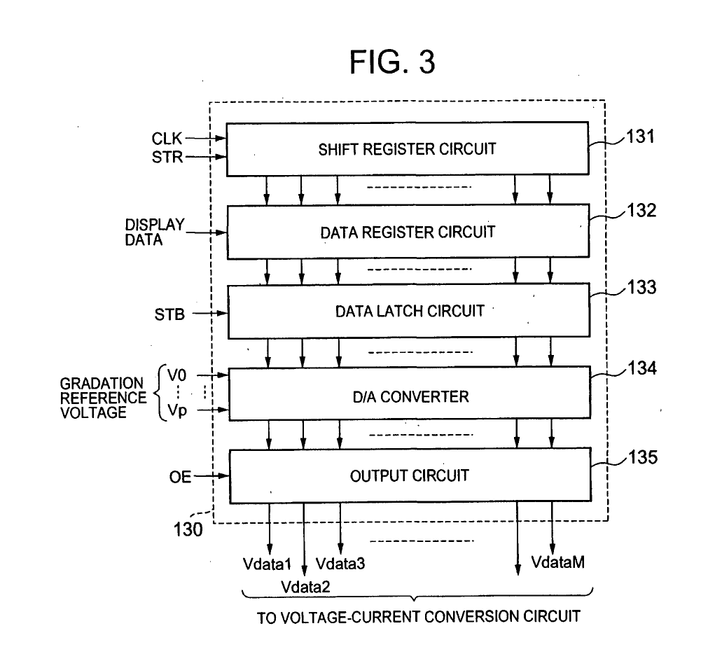

FIG. 3 is a block diagram showing the outline configuration of the signal voltage generation circuit as applied to the display device related to the first embodiment.

The signal voltage generation circuit 130 has a configuration equivalent to a well-known voltage driver (a driver which generates and outputs a gradation signal voltage corresponding to the display data) as a peripheral circuit of the display device 100. The display data which consists of a digital signal is taken in and held at predetermined timing and outputted from the display signal generation circuit 160 based on data control signals supplied from the system controller 150. Subsequently, analog signal voltage corresponding to that display data is generated and outputted to the voltage-current conversion circuit 140A described as the signal voltage Vdata (Vdata˜VdataM) mentioned above.

Specifically, for example as shown in FIG. 3, the signal voltage generation circuit 130 configuration comprises a shift register circuit 131, a data register circuit 132, a data latch circuit 133, a Digital/Analog (D/A) converter 134 and an output circuit 135. The shift register circuit 131 outputs a shift signal sequentially based on a shift clock signal CLK and a sampling start signal STR. The data register circuit 132 takes in sequentially the display data for one line periods supplied from the display signal generation circuit 160 based on the input timing of this shift signal. The data latch circuit 133 performs batch storage of the display data for one line periods taken in by the data register circuit 132 based on a data latch signal STB. The D/A converter 134 converts the held display data described above into a predetermined analog signal voltage based on a gradation reference voltage V0˜Vp. The output circuit 135 outputs the analog signal voltage to the voltage-current conversion circuit 140A according to timing based on an output enable signal OE as the signal voltage Vdata (Vdata1˜VdataM) corresponding to each of the data lines DL. Here, at least the shift clock signal CLK, the sampling start signal STR, the data latch signal STB and the output enable signal OE mentioned above are supplied as data control signals from the system controller 150.

(Voltage-Current Conversion Circuit)

The voltage-current conversion circuit 140A, for example as shown in FIG. 2, is set for each of the data lines DL. The configuration has a plurality of switches SW1, SW2, . . . SWAm (hereinafter denoted as “switches SWA”; conversion circuit section) for supplying a signal current which flows corresponding to the signal voltage Vdata to the display pixels of each column via each of the data lines DL as the gradation current Ipix and performs an “ON” operation by a predetermined continuity condition (switch “ON/OFF” operation) based on the signal voltage Vdata supplied from the signal voltage generation circuit 130 mentioned above.

Here, each of the switches SWA has a configuration comprising a Thin-Film Transistor Trl1 (switching element) connected to a voltage supply line and to the data lines DL wherein the source terminals and the drain terminals are connected to a predetermined negative supply voltage Vss (for example, −20V; power supply voltage) and the signal voltage Vdata outputted from the above-stated signal voltage generation circuit 130 is applied to the gate terminals. The Thin-Film Transistors Trl1 are n-channel type Thin-Film Transistors (TFT) (hereinafter denoted as Nch transistors Trl1) which use amorphous silicon. Accordingly, as the voltage-current conversion circuit 140A related to the first embodiment can be produced relatively cheaply with the application of an already established amorphous silicon manufacturing technology, stable operating characteristics can be achieved.

In particular, a Thin-Film Transistor using amorphous silicon has a device characteristic in which current can be generated having an extremely minute current value in the order of a few tenths of a nano-amp (nA) with relatively high accuracy as compared with a MOS transistor formed on a single-crystal silicon substrate described later.

In the voltage-current conversion circuit 140A, since the Nch transistor Trl1 of each of the switching circuits SWA perform an “ON” operation by a predetermined continuity condition based on the voltage value of the signal voltage Vdata (analog signal) generated by the signal voltage generation circuit 130 corresponding to the display data which consists of a digital signal supplied from the display signal generation circuit 160, a signal current having a predetermined current value corresponding to that display data (luminosity gradation) is generated which is then batched or outputted sequentially to each of the data lines DL by converting this signal current as the gradation current Ipix.

(System Controller)

The system controller 150, by outputting at least scanning control signals (the scanning start signal SST, the scanning clock signal SCK, etc.) and data control signals (the shift clock signal CLK, the sampling start signal STR, the data latch signal STB, the output enable signal OE, etc. mentioned above) which control the operational state respectively to the scanning driver 120 and the signal voltage generation circuit 130, results in each driver and control circuit operated at predetermined timing. The scanning signal Vsel and the gradation current Ipix are generated and then applied to each of the scanning lines SL and the data lines DL. Moreover, light generation operation is carried out consecutively in each of the display pixels EM and controlled to display the image information based on a predetermined video signal.

(Display Signal Generation Circuit)

The display signal generation circuit 160, for example, extracts a luminosity gradation signal component from a video signal supplied externally from the display device 100 and supplies this luminosity gradation signal component for each one line period of the display panel 110 to the data register circuit 132 of the signal voltage generation circuit 130 as the display data which consists of a digital signal. Here, when the above-mentioned video signal includes a timing signal component which specifies display timing of image information such as a television broadcast signal (composite video signal) the display signal generation circuit 160 as shown in FIG. 1 may have a function which extracts a timing signal component besides a function which extracts the above-mentioned luminosity gradation signal component and supplied to the system controller 150. In this case, the above-stated system controller 150 generates scanning control signals and data control signals which are supplied individually to the scanning driver 120 or the signal voltage generation circuit 130 based on a timing signal supplied from the display signal generation circuit 160.

When a video signal supplied externally of the display device 100 is formed by a digital signal and the timing signal is supplied in addition to the video signal, while supplying the video signal (digital signal) as the display data unchanged to the signal voltage generation circuit 130, the display signal generation circuit 160 may be excluded as the timing signal is supplied to the system controller 150 directly. Referring to FIG. 1, in the drive control method of the display device illustrated below, the display data and timing signal are each other generated by the display signal generation circuit 160 based on a video signal and a case wherein the signal voltage generation circuit and the system controller 150 are supplied will be explained.

(Illustrative Circuit Example of the Display Pixels)

Subsequently, an illustrative circuit example of the display pixels as applied to the display panel related to the first embodiment will be explained with reference to the drawings.

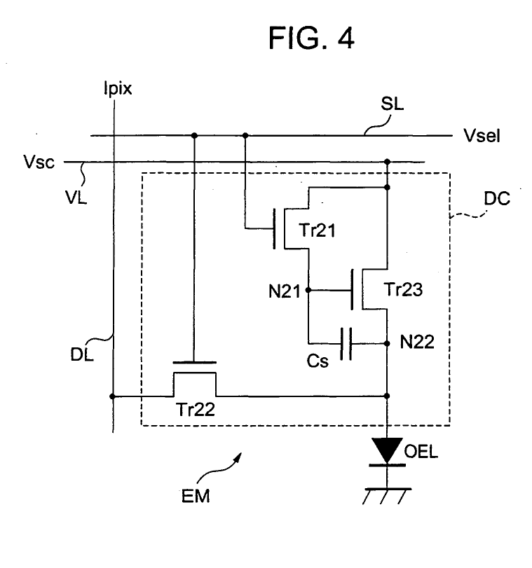

FIG. 4 is a circuit configuration drawing showing an illustrative circuit example of a pixel driver circuit of the display pixels as applied to the display device related to the present invention.

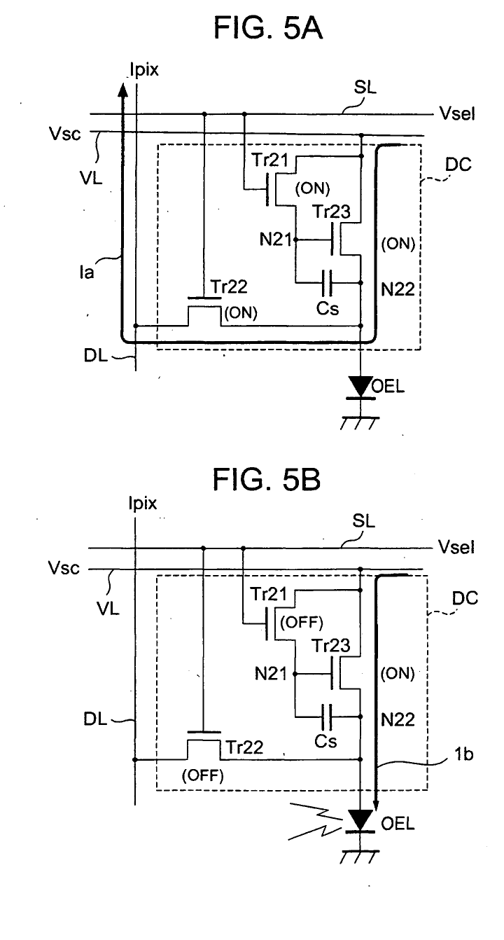

FIGS. 5A and 5B are conceptual diagrams showing the display pixel drive control operation as applied to the display device related to the present invention.

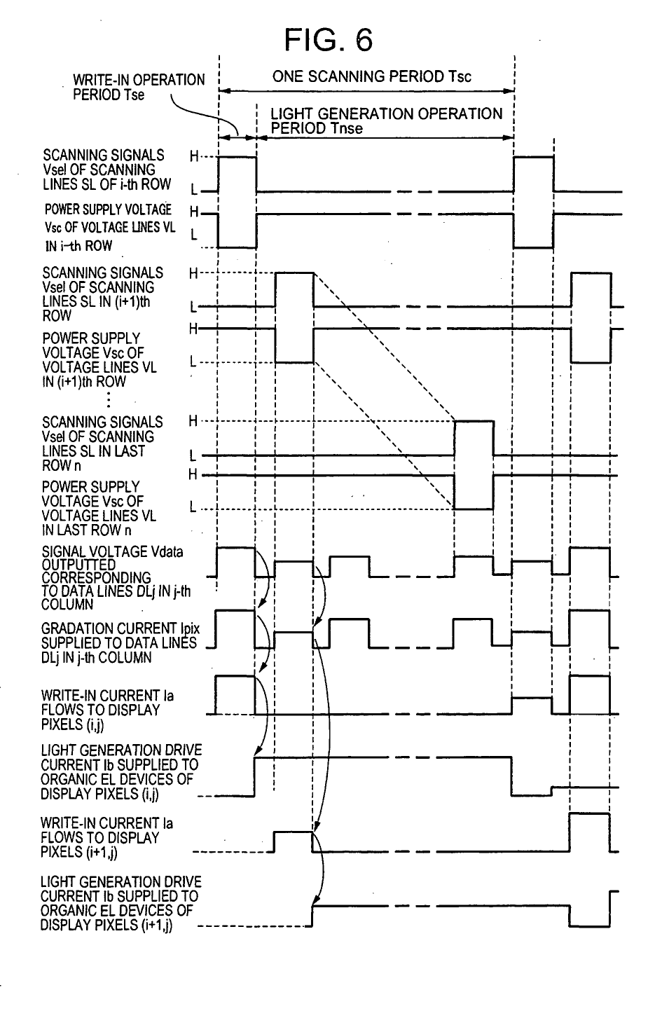

FIG. 6 is a timing chart showing the display drive operation of the display device applied to the display pixels related to the illustrative example.

In addition, a pixel driver circuit shown here represents only one example applicable to the display device related to the present invention. It is emphasized that other circuit configurations having equivalent operational functions may be applied.

The display pixels EM related to the embodiment, in summary and as shown in FIG. 4 for example, have a configuration of pixel driver circuits DC (emission drive circuits) which set the display pixels EM in a selection state based on the scanning signal Vsel applied from the scanning driver 120 mentioned above, take in the gradation current Ipix supplied from the signal voltage generation circuit 130 and the voltage-current conversion circuit 140 in this selection state, and flow light generation drive current corresponding to the current value of this gradation current Ipix to the light emitting devices; and also current control type light emitting devices, such as organic EL devices OEL, etc., which perform light generation operation by predetermined luminosity gradation based on a light generation drive current supplied from these pixel driver circuits DC.

The pixel driver circuits DC, for example and as shown in FIG. 4, have a configuration comprising an n-channel type Thin-Film Transistor Tr21 (hereinafter denoted as an “Nch transistor), an Nch transistor Tr22, an Nch transistor Tr23 and a capacitor Cs (also called a condenser). The Nch transistor Tr21 is connected one another with the gate terminal to the scanning lines SL, the source terminal to the voltage line VL arranged in parallel to the scanning lines SL and the drain terminal to a contact N21. The Nch transistor Tr22 is connected to one another with the gate terminal to the scanning lines SL, along with the source terminal and the drain terminal to the data lines DL and a contact N22. The Nch transistor Tr23 is connected to one another with the gate terminal to the contact N21, along with the source terminal and the drain terminal to the voltage line VL and the contact N22. The capacitor Cs is connected between the contact N21 and the contact N22.

Furthermore, the organic EL devices OEL in which light generation luminosity is controlled by a light generation drive current supplied from the pixel driver circuits DC have a configuration in which each other are connected with the anode terminal to the contact N22 of the above-stated pixel driver circuits DC and the cathode terminal to ground potential Vgnd. Here, the capacitor Cs may be a parasitic capacitor positioned between the gate-source of the Nch transistor Tr23 and a second capacitative element can be added separately further between the gate-source in addition to the parasitic capacitor.

The display pixel drive control operation comprising the pixel driver circuits DC which have such a configuration, for example as shown in FIG. 6, performs by setting (Tsc=Tse+Tnse). One scanning period Tsc denotes one cycle. A write-in operation period Tse (selection period) within this one scanning period Tsc selects the display pixels of a plurality of lines connected to a specific scanning lines group SLi, writes in the gradation current Ipix corresponding to the display data and is held as a voltage component. A light generation operation period Tnse (non-selection period) which writes in this selection period Tse then supplies a light generation drive current that has a current value corresponding to the above-stated display data to the organic EL devices OEL based on the held voltage component and performs light generation operation by predetermined luminosity gradation. Here, the selection period Tse is set for each of the scanning line groups SLi connected to the display pixels EM of a plurality of lines so that a time period overlap does not occur with one another.

First, in the write-in operation period Tse of the display pixels, as shown in FIG. 6, as the scanning signal Vsel of a high-level (selection level) is applied relative to the scanning lines SL of the i-th (1≦i≦n) row from the scanning driver 120, a power supply voltage Vsc of a low-level is applied to the voltage line VL. Furthermore, synchronizing with this timing, by generating and outputting the signal voltage Vdata corresponding to the display data from the signal voltage generation circuit 130, this signal voltage V data will be applied to the switches SWA (gate terminal of Nch transistors Trl1) set for each of the data lines DL of the voltage-current conversion circuit 140A. The switches SWA (Nch transistors Trl1) perform an “ON” operation by a continuity condition corresponding to this signal voltage Vdata (gate voltage) and the gradation current Ipix having a predetermined current value is supplied to the data lines DL.

Here, the gradation current Ipix is set to a predetermined current value necessary in order to perform light generation operation by predetermined luminosity gradation of the organic EL devices OEL in each of the display pixels EM based on a gradation data component included in the display data supplied from the display signal generation circuit 160.

Accordingly, as Nch transistor Tr21 and Tr22 constituted in the pixel driver circuits DC perform “ON” operations and the power supply voltage Vsc of a low-level is applied to the contact N21 (namely, the gate terminal side of Nch transistor Tr23 and one end side of the capacitor Cs) . By connecting to negative supply voltage (−20V) lower than the power supply voltage Vsc of a low-level, the other end side of the switches SWA (Nch transistor Trl1) current path is set to each of the data lines DL. In this manner, the gradation current Ipix of negative polarity will be supplied to each of the data lines DL and a voltage level of low potential is applied to the contact N22 (namely, the source terminal side of Nch transistor Tr23 and the other end side of the capacitor Cs) rather than the power supply voltage Vsc of a low-level via Nch transistor Tr22.

Thus, referring now to FIG. 5A, when a potential difference arises between the contact N21 and N22 (between the gate-source of the Nch transistor Tr23), the Nch transistor Tr23 performs an “ON” operation and a write-in current Ia flows so as to be drawn corresponding to the gradation current Ipix in the direction of the voltage-current conversion circuit 140A from the voltage line VL via the Nch transistor Tr23, the contact N22, the Nch transistor Tr22 and the data lines DL. Also, at this instance, an electric charge corresponding to the potential difference produced between the contact N21 and N22 is stored in the capacitor Cs and is held as the voltage component (charge). Also, at this time, the power supply voltage Vsc of a low-level which has a voltage level less than ground potential is applied to the voltage line VL and further controlled so that the write-in current Ia flows in the direction of the data lines DL. Because the potential applied to the anode terminal (contact N22) of the organic EL devices OEL becomes lower than the potential (ground potential) of the cathode terminal, reverse-bias voltage will be applied to the organic EL devices OEL, light generation drive current does not flow into the organic EL devices OEL, light generation operation is not performed and set in a non-operational state.

Subsequently, in the light generation operation period Tnse after termination of a write-in operation period Tse, as shown in FIG. 6, the scanning signal Vsel of a low-level (non-selection level) is applied relative to the scanning lines SL of the i-th row from the scanning driver 120, the power supply voltage Vsc of a high-level which has a voltage level higher than ground potential is applied to the voltage line VL. Furthermore, synchronizing with this timing, output of the signal voltage Vdata from the signal voltage generation circuit 130 is blocked out (shutdown) and the drawing in process of the gradation current Ipix by the voltage-current conversion circuit 140A is suspended.

As a result, the display pixels EM of the i-th row are set in a non-selection state, Nch transistor Tr21 and Tr22 perform an “OFF” operation and application of the power supply voltage Vsc to the contact N21 is blocked out. Because application of the voltage level attributable to the drawing in process of the gradation current Ipix to the contact N22 is blocked out, the capacitor Cs holds the electric charge stored in the write-in operation period Tse mentioned above.

Thus, when the capacitor Cs holds the charge voltage of the write-in operation period Tse, the potential difference between the contact N21 and N22 (between gate-source of the Nch transistor Tr23) will be held and Nch transistor Tr23 maintains an “ON” state. Furthermore, as shown in FIG. 5B, since the power supply voltage Vsc having a voltage level higher than ground potential is applied to the voltage line VL, a light generation drive current Ib flows in the direction of forward-bias voltage to the organic EL devices OEL via Nch transistor Tr23 and the contact N22 from the voltage line VL. In this manner, the organic EL devices OEL are set in an operational state and light generation operation is performed.

Here, because the potential difference (charge voltage) by the electric charge held in the capacitor CS is equivalent to the potential difference at the time of flowing the write-in current Ia corresponding to the gradation current Ipix to Nch transistor Tr23 in the above-stated write-in operation period Tse, the light generation drive current Ib which flows into the organic EL devices OEL will have a current value equivalent to the above-stated write-in current Ia. In a light generation operation period Tnse, the organic EL devices OEL continue light generation operation by predetermined luminosity gradation corresponding to the display data based on the voltage component corresponding to the current value of the gradation current Ipix supplied during the write-in operation Tse.

Therefore, as shown in FIG. 6, by executing such a sequence of drive control operations repeated sequentially using the scanning driver 120, the signal voltage generation circuit 130 and the voltage-current conversion circuit 140A in all rows of the display pixels EM groups which constitute the display panel 110, one screen of display data is written in and each of the display pixels EM emit light by predetermined luminosity gradation to display the desired image information.

Here, the Nch transistors Tr21˜Tr23 applied to the pixel driver circuits DC related to the illustrative example, for instance, can be constituted with all n-channel type Thin-Film Transistors. Accordingly, because the pixel driver circuits DC can be composed by applying n-channel type Thin-Film transistors (switching elements) that use amorphous silicon, an already established manufacturing technology can be applied and the pixel driver circuits DC with stable operating characteristics can be produced relatively cheaply.

Next, the operational effectiveness when applying Thin-Film Transistors (also called TFT) which use amorphous silicon in the display device (particularly, the voltage-current generation circuit) related to the first embodiment will be examined.

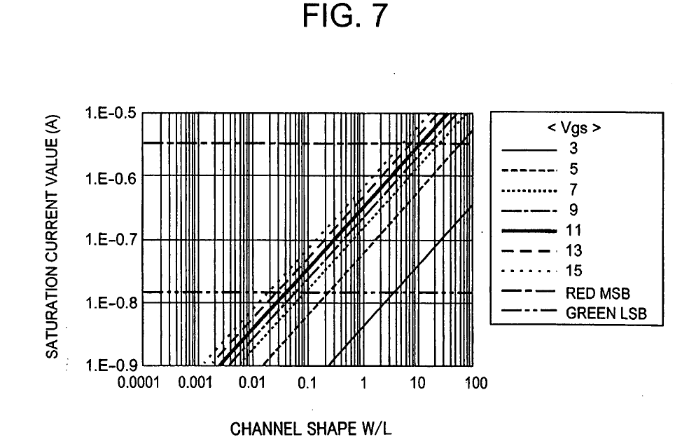

FIG. 7 is a characteristic drawing showing the distinction of saturation current relative to a Thin-Film Transistor which uses amorphous silicon.

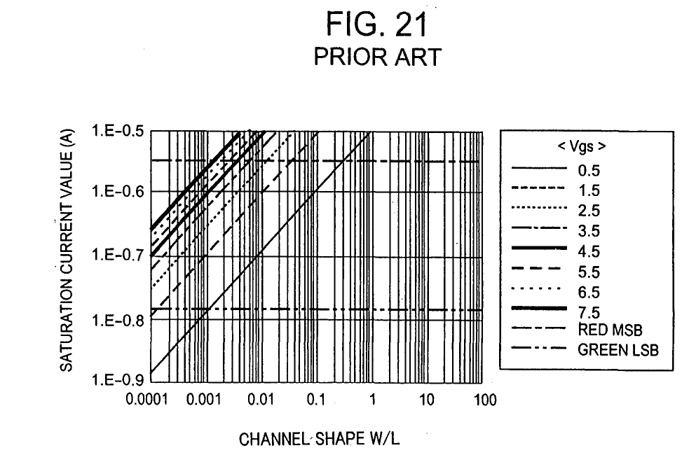

The saturation current characteristic (refer to FIG. 21) in an MOS transistor shown in the conventional prior art mentioned above will be suitably referenced in the explanation.

In the voltage-current conversion circuit 140A composed of Thin-Film Transistors which use amorphous silicon related to the first embodiment, the current range (12.8 nA˜3.05 μA) of the light generation drive current required for light generation operation in the organic EL devices is set when the display panel consists of the design specifications as shown in Table 1 mentioned above. When the relationship of the Thin-Film transistor channel shape (W/L) is examined, in order to generate light generation drive current which has the current range mentioned above, as shown in FIG. 7, typically W/L=3 will be sufficient as the channel shape and what is required is just to control by about Vgs=3V˜16V generally as the voltage between the gate-source of the Thin-Film transistor. Therefore, the aspect ratio of that planar shape more closely resembles a rectangle relatively to 1. In this approach, the present invention has the capability to substantially control the influence of processing accuracy variations derived from the manufacturing process of Thin-Film transistors and perform equalization of the operating characteristics. Additionally, the present constraints on circuit design and inefficiency in planar circuit formation dimensions can be substantially optimized.

The variance in the element characteristic (saturation current characteristic) of a Thin-Film Transistor which uses amorphous silicon and the element characteristic of a MOS transistor is attributable to the difference in electron mobility between amorphous silicon and single-crystal silicon. More specifically, the electron mobility of single-crystal silicon is about 900 cm2/Vs whereas the electron mobility in amorphous silicon is about 0.5cm2/Vs. There is such an extremely high difference in the electron mobility of amorphous silicon.

Accordingly, Thin-Film Transistors which use amorphous silicon are applied to the voltage-current conversion circuit of the first embodiment. A signal voltage having a current value corresponding to the display data is generated using a signal voltage generation circuit which consists of a general purpose (common knowledge) voltage driver to a display panel according to a current application type method. Because gradation current having a current range suitable for drive controlling of the above-mentioned display panel can be generated and supplied by a voltage-current conversion circuit based on this signal voltage, markedly improved drive controlling of the display panel can be performed with a current application type method, as well as comprising a configuration which is relatively simplified and inexpensive.

In the embodiment, although only a case that relates to Thin-Film type Transistors which use amorphous silicon as switching elements in a voltage-current conversion circuit configuration is explained, it is mainly important to utilize Field Effect type Transistors (FETs) formed using a semiconductor which has relatively low electron mobility as described above. For example, even if the electron mobility applies to a transistor configuration using polycrystalline silicon or oxide semiconductor, organic conductor, etc. lower than 50 cm2/Vs generally, the equivalent operational effect to the above-stated can be acquired.

### Second Embodiment

Next, the second embodiment of the display device which can apply the driver apparatus related to the present invention will be explained with reference to the drawings.

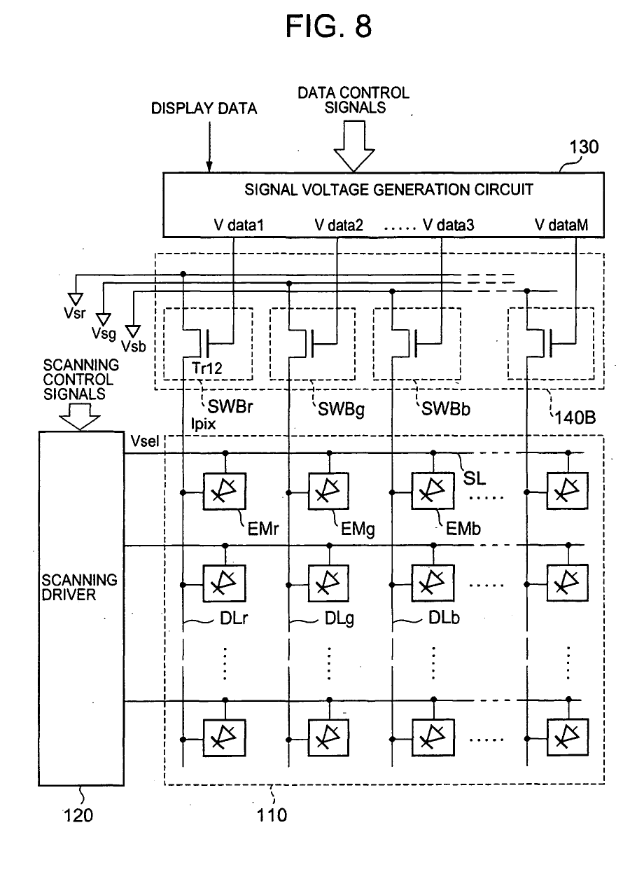

FIG. 8 is an outline block diagram showing an example of the main section configuration in the second embodiment of the display device applied to the driver apparatus related to the present invention.

Here, with respect to any configuration equivalent to the first embodiment mentioned above, the same or equivalent nomenclature is appended and the explanation is simplified or omitted from the description.

In the first embodiment mentioned above, the configuration of the voltage-current conversion circuit has a configuration connected in common to a negative supply voltage containing a single negative voltage and the other end side of the current path of each switch (Thin-Film Transistor) is provided for each of the data lines. In this second embodiment, the voltage-current conversion circuit is configured so that light generation luminosity of each luminous color can be converted into an appropriate value corresponding to the difference in the luminosity characteristic of each luminous color by connecting with a negative supply voltage having a different voltage value for each luminous color of the display pixels arranged in the display panel.

The display panel as applied to the display device related to the second embodiment, as shown in FIG. 8, has a configuration comprising the display pixels EMr, EMg and EMb arranged systematically which emit light as the luminous colors of red (r), green (g), blue (b). Furthermore, the display pixels EMr, Emg and Emb of each luminous color are connected to the data lines DLr, DLg and DLb respectively. The voltage-current conversion circuit 140A comprises the switches SWBr, SWBg and SWBb set corresponding to each of the data lines DLr, DLg and DLb. One end side of each current path of the switches SWbr, SWBg and SWBb (Thin-Film Transistors Trl2) is connected to each of the above-stated data lines DLr, DLg and DLb along with the other end side connected to a power supply voltage Vsr, Vsg and Vsb in which each other has a different voltage value.

Here, the luminosity characteristic (relation between gradation current and light generation luminosity) in the display pixels (light emitting devices) EMr, Emg and Emb which emit light for each luminous color, for example, as also shown in Table 2 mentioned above, which differs depending on the luminous color is realized. Specifically, with regard to the relationship between gradation current and light generation luminosity when performing light generation operation at maximum luminosity gradation, even though red light requires a higher current as compared with green light or blue light, light generation luminosity is relatively low. On the other hand, green light has a characteristic that high light generation luminosity is acquired with a lower current as compared with red light or blue light. Therefore, as shown in the first embodiment mentioned above, when applied to a display panel corresponding to a color display configuration in which each switch connected to a single negative supply voltage has the same voltage value, disparity in the luminosity characteristic for each luminous color may occur and deterioration of the image quality, such as display unevenness, etc. may happen.

Consequently, in this embodiment based on the signal voltage corresponding to the display data, the value of the negative supply voltage connected to the switches that generate gradation current corresponding to predetermined luminosity gradation respective to the luminous colors of the display panel are set as suitable values which become relatively higher for green light and relatively lower for red light. For example, such as:
Vsr=−20V, Vsg=−20V+αV, Vsb=−20V+βV (α>β).
Since the current value of the gradation current supplied to the display pixels of each luminous color can be set as an appropriate value in this manner, the light generation luminosity for each luminous color can be set appropriately and improvement in the display image quality can be achieved.

Also, in the embodiment, a configuration which can set a variable negative supply voltage individually set for each luminous color may be applied. Owing to this, control of fluctuations of the light generation luminosity depending on temperature conditions or adjustment of the light generation luminosity of the entire display panel can be performed.

Moreover, as illustrated in the embodiment, a configuration which sets individually a voltage value of the negative supply voltage corresponding to luminous colors of the display pixels is applicable not only to the first embodiment mentioned above but also a configuration of subsequent third embodiment described later.

### Third Embodiment

Next, the third embodiment of the display device which can apply the driver apparatus related to the present invention will be explained with reference to the drawings.

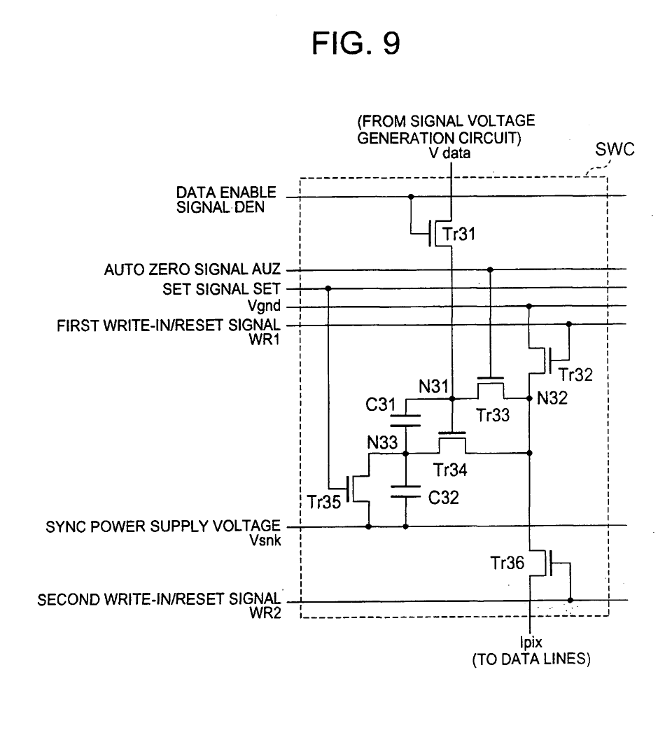

FIG. 9 is an outline block diagram showing an example of the main section in the third embodiment of the display device applied to the driver apparatus related to the present invention.

Here, with respect to any configuration equivalent to the first or second embodiment mentioned above, the same or equivalent nomenclature is appended and the explanation is simplified or omitted from the description.

In the first and second embodiments mentioned above, inside the voltage-current conversion circuit, a Thin-Film Transistor composed from amorphous silicon is applied as a switch set for each data line and accordingly illustrated that a circuit with superior operating characteristics can be manufactured relatively cheaply.

However, in Thin-Film Transistors consisting of amorphous silicon, the operating characteristic (particularly threshold voltage; device characteristic) tends to fluctuate over time and acquiring a stabilized characteristic on a long-term basis is troublesome. Hereby, the value of the gradation current supplied to each data line corresponding to the signal voltage supplied will fluctuate over time. Therefore, the third embodiment is characterized by having a circuit configuration which can control the fluctuation effects in the operating characteristic (threshold voltage) of Thin-Film Transistors made of amorphous silicon.

In the voltage-current conversion circuit related to the third embodiment, as shown in FIG. 9, each switching circuit section SWC (conversion circuit part, compensation circuit) is set for each of the data lines, for example, has a configuration comprising an n-channel type Thin-Film Transistor Tr31 (hereinafter denoted as “Nch transistor”), an Nch transistor Tr32, an Nch transistor Tr33, an Nch transistor Tr34 (voltage-current conversion transistor), an Nch transistor Tr35, an Nch transistor Tr36, a capacitor C31 (capacity component) and a capacitor C32 (capacity component). The Nch transistor Tr31 wherein a data enable signal DEN is applied to the gate terminal, along with the source terminal and the drain terminal is applied each other to the signal voltage Vdata from the above-stated signal voltage generation circuit 130 in one direction and connected to a contact N31 in the other direction. The Nch transistor Tr32 wherein a first pixel write-in/reset signal WR1 is applied to the gate terminal, along with the source terminal and the drain terminal is applied each other to the ground potential Vgnd in one direction and connected to a contact N32 in the other direction. The Nch transistor Tr33 wherein an auto zero signal AUZ is applied to the gate terminal, along with the source terminal and the drain terminal is connected each other to the contact N31 in one direction and the contact N32 in the other direction. The Nch transistor Tr34 (voltage-current conversion transistor) wherein the contact N31 is connected to the gate terminal, along with the source terminal and the drain terminal is connected each other to the contact N32 in one direction and a contact N33 in the other direction. The Nch transistor Tr35 wherein a set signal SET is applied to the gate terminal, along with the source terminal and the drain terminal is connected each other to the contact N33 in one direction and a sync power supply voltage Vsnk (negative supply voltage: for example, −18V) is applied in the other direction. The Nch transistor Tr36 wherein a second pixel write-in/reset signal WR2 is applied to the gate terminal, along with the source terminal and the drain terminal is connected each other to the data lines DL of each column in one direction and is connected to the contact N32 in the other direction. The capacitor C31 (capacity component) is connected between the contact N31 and the contact N33. The capacitor C32 is connected between the contact N33 and the supply contact of the sync power supply voltage Vsnk. The capacitor C32 has a sufficiently higher capacitance value (C31<C32) than the capacitor C31.

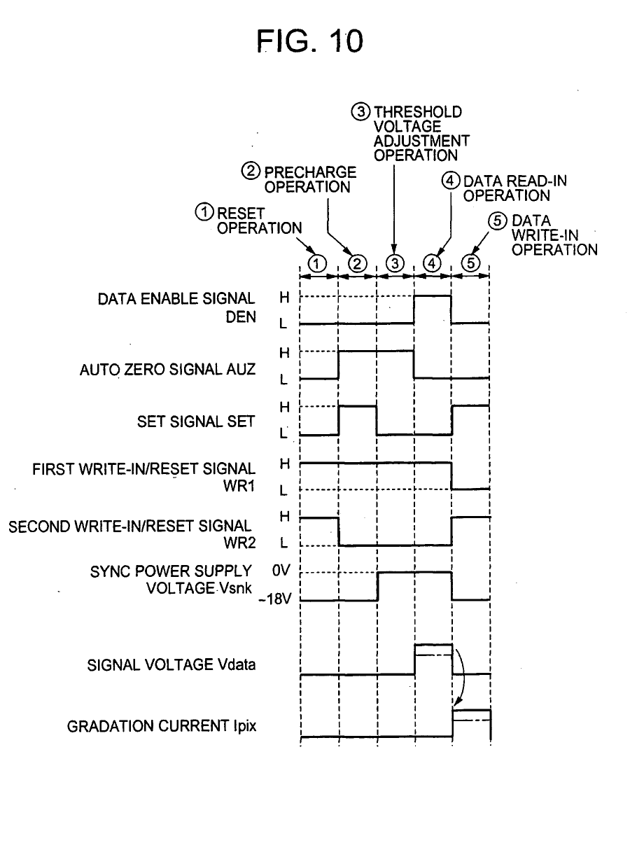

Here, the data enable signal DEN, the first pixel write-in/reset signal WR1, the auto zero signal AUZ, the set signal SET and the second pixel write-in/reset signal WR2 are applied to each gate terminal of the Nch transistors Tr31˜Tr33, Tr35 and Tr36 are respectively set, for example, as a predetermined signal level as shown in the timing chart (refer to FIG. 10) described later by the system controller 150 mentioned above and is outputted as part of the data control signals to predetermined signal timing.

The switching circuit section SWC as shown in FIG. 9, which constitutes the switching circuit section is formed at least with the Nch transistors Tr31˜Tr36 applied with a morphous silicon during the manufacturing process.

Subsequently, the drive control operation in the voltage-current generation circuit which has a configuration mentioned above will be explained with reference to the drawings.

FIG. 10 is a timing chart showing the drive control operation in the voltage-current conversion circuit (switching circuit section) related to the third embodiment.

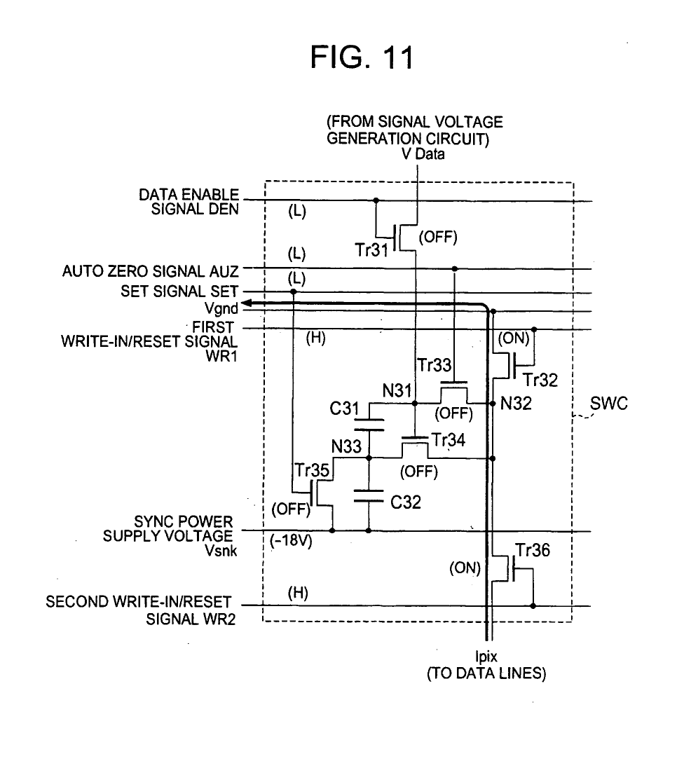

FIGS. 11˜15 are conceptual diagrams showing the process of the reset operation in the voltage-current conversion circuit (switching circuit section) related to the third embodiment.

A period which includes a write-in operation period within a predetermined one cycle interval (for instance, one scanning period),as shown in FIG. 10, is performed by setting sequentially a reset operation period, a precharge operation period, a threshold voltage adjustment operation period, a data read-in operation period and a data write-in operation period. Here, at least for the data write-in operation period, signal timing is set so that all or a portion of the write-in operation period mentioned above can be in consonance.

(Reset Operation)

In the reset operation related to the third embodiment, initially as shown in FIG. 10, by supplying the voltage-current conversion circuit with the data enable signal DEN of a low-level, the auto zero signal AUZ of a low-level, the set signal SET of a low-level, the first pixel write-in/reset signal WR1 of a high-level and the second pixel write-in/reset signal WR2 of a high-level from the system controller 150, the Nch transistors Tr31, Tr33˜Tr35 perform an “OFF” operation and the Nch transistors Tr32 and Tr36 perform an “ON” operation. At this time, a voltage value of the synch power supply voltage Vsnk is set, for example, as −18V.

Accordingly, as shown in FIG. 11, because each of the data lines DL are connected to the ground potential Vgnd via the current path of Nch transistors Tr36 and Tr32, a signal level of the data lines DL is reset to a low-level (0V). Because the Nch transistor Tr31 performs an “OFF” operation at this time, the switching circuit section SWC and the signal voltage generation circuit 130 will be in an electrically separated state. Therefore, the Nch transistors Tr36 and Tr32 at least constitute a reset circuit related to the present invention.

(Precharge Operation)

Secondly, in the precharge operation related to the third embodiment, as shown in FIG. 10, by supplying the voltage-current conversion circuit with the data enable signal DEN of a low-level, the auto zero signal AUZ of a high-level, the set signal SET of a high-level, the first pixel write-in/reset signal WR1 of a high-level and the second pixel write-in/reset signal WR2 of a low-level from the system controller 150, the Nch transistors Tr31 and Tr36 perform an “OFF” operation and the Nch transistors Tr32˜Tr35 perform an “ON” operation.

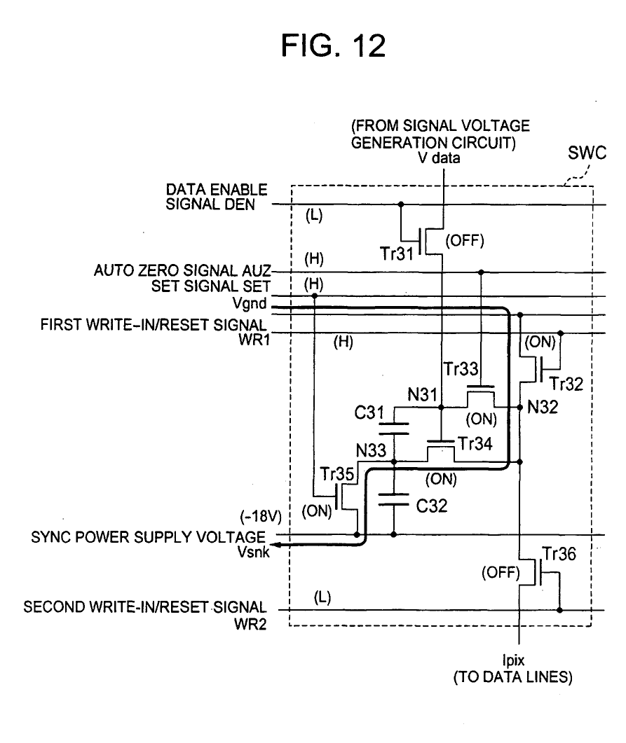

Accordingly, as shown in FIG. 12, because predetermined precharge current flows between the ground potential Vgnd and the sync power supply voltage Vsnk via the Nch transistor Tr32, Tr34 and Tr35, the current path at both ends of the capacitor C31 are connected between gate-source of the Nch transistor Tr34 (between the contacts N31 and N33). Thus, the ground potential Vgnd (=0V) and the sync power supply voltage Vsnk (for example, −18V) are applied and the electric charge corresponding to this potential difference (18V) is charged to the capacitor C31.

Additionally at this time, because the Nch transistor Tr36 performs an “OFF” operation, the data lines DL arranged in the switching circuit SWC and the display panel 110 will be in an electrically separated state.

(Threshold Voltage Adjustment Operation)

Subsequently, in the threshold voltage adjustment operation related to the third embodiment, as shown in FIG. 10, by supplying the voltage-current conversion circuit with the data enable signal DEN of a low-level, the auto zero signal AUZ of a high-level, the set signal SET of a low-level, the first pixel write-in/reset signal WR1 of a high-level and the second pixel write-in/reset signal WR2 of a low-level from the system controller 150, the Nch transistors Tr31, Tr35 and Tr36 perform an “OFF” operation and the Nch transistors Tr32˜Tr34 perform an “ON” operation. Simultaneously at this time, the voltage value of the sync power supply voltage Vsnk is switched and set as 0V from −18V.

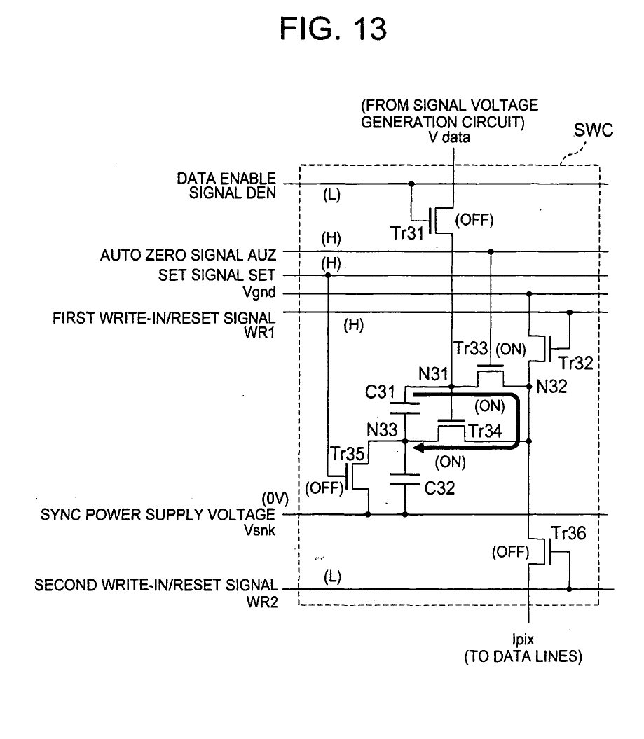

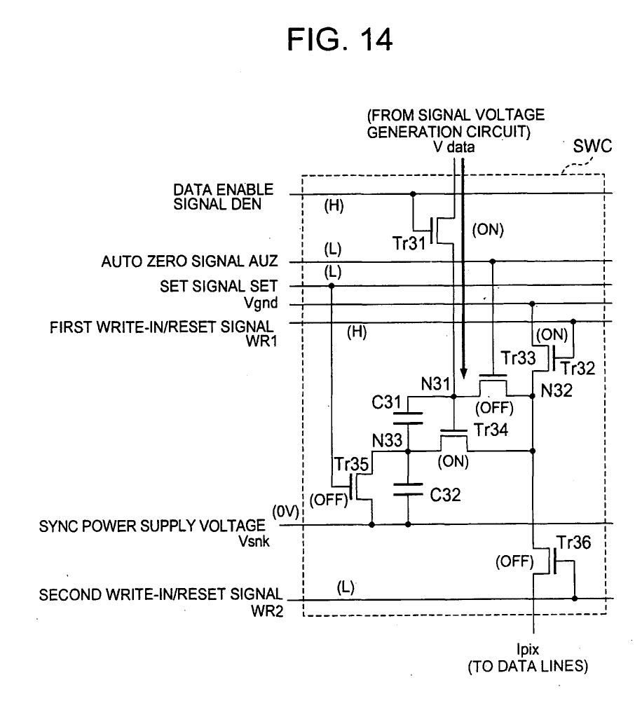

Accordingly, as shown in FIG. 13, because the ground potential Vgnd (=0V) will be applied to the contact N33 via the Nch transistors Tr32 and Tr34, the potential of the contact N31 changes from 0V to 18V based on the charged voltage (18V) in the capacitor C31. Therefore, the electric charge stored in the capacitor C31 is discharged to the contact N33 side via Nch transistors Tr33 and Tr34 from the contact N31 side and the current flows into the contact N33 side from the contact N31 side. Here, when the electric charge stored in the capacitor C31 is discharged and current flows, the charge voltage (potential difference between the contacts N31 and N33) of the capacitor C31 declines gradually. Because the voltage between source-gate of the Nch transistor Tr34 constitutes a threshold voltage Vth, if the charge voltage of the capacitor C31 declines to a voltage (precharge voltage) equivalent to the threshold voltage Vth of the Nch transistor Tr34, current will not flow. Namely, by the threshold voltage adjustment operation, the electric charge equivalent to the threshold voltage Vth of the Nch transistor Tr34 will be stored (accumulated) in the capacitor C31. Therefore, the Nch transistors Tr32˜Tr35 and the capacitor C31 at least constitute a precharge circuit related to the present invention.

(Data Read-In Operation)

Next, the data read-in operation related to the third embodiment, as shown in FIG. 10, by supplying the voltage-current conversion circuit with the data enable signal DEN of a high-level, the auto zero signal AUZ of a low-level, the set signal SET of a low-level, the first pixel write-in/reset signal WR1 of a high-level and the second pixel write-in/reset signal WR2 of a low-level from the system controller 150, as the Nch transistors Tr31 and Tr32 perform an “ON” operation; the Nch transistors Tr33, Tr35 and Tr36 perform an “OFF” operation. Simultaneously at this time, the voltage value of the sync power supply voltage Vsnk is continuously and set as 0V.

Accordingly, as shown in FIG. 14, the signal voltage Vdata corresponding to the display data is applied to the contact N31 from the signal voltage generation circuit 130 via the Nch transistor Tr31. Because a sum total voltage (Vth+Vdata) will be applied to the threshold voltage Vth of the Nch transistor Tr34 mentioned above at the contact N31 (gate terminal of the Nch transistor Tr34), the Nch transistor Tr34 performs an “ON” operation by a continuity condition corresponding to this signal voltage Vdata. Therefore, the Nch transistor Tr31 at least constitutes a read-in circuit related to the present invention.

(Data Write-In Operation)

Subsequently, in the data write-in operation related to the third embodiment, as shown in FIG. 10, by supplying the voltage-current conversion circuit with the data enable signal DEN of a low-level, the auto zero signal AUZ of a low-level, the set signal SET of a high-level, the first pixel write-in/reset signal WR1 of a low-level and the second pixel write-in/reset signal WR2 of a high-level from the system controller 150, as the Nch transistors Tr31˜Tr33 perform an “OFF” operation; the Nch transistors Tr34˜Tr36 perform an “ON” operation. At this time, the voltage value of the sync power supply voltage Vsnk is simultaneously switched and set as −18V from 0V.

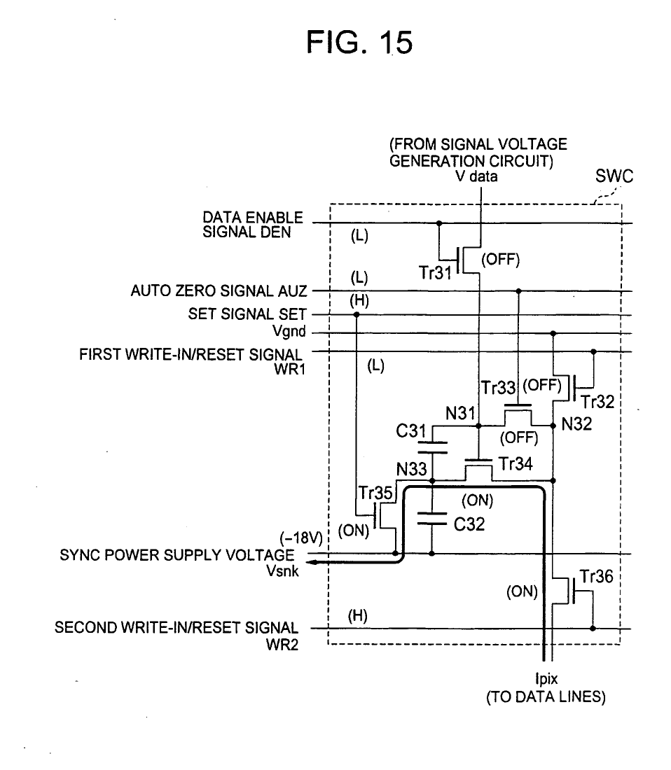

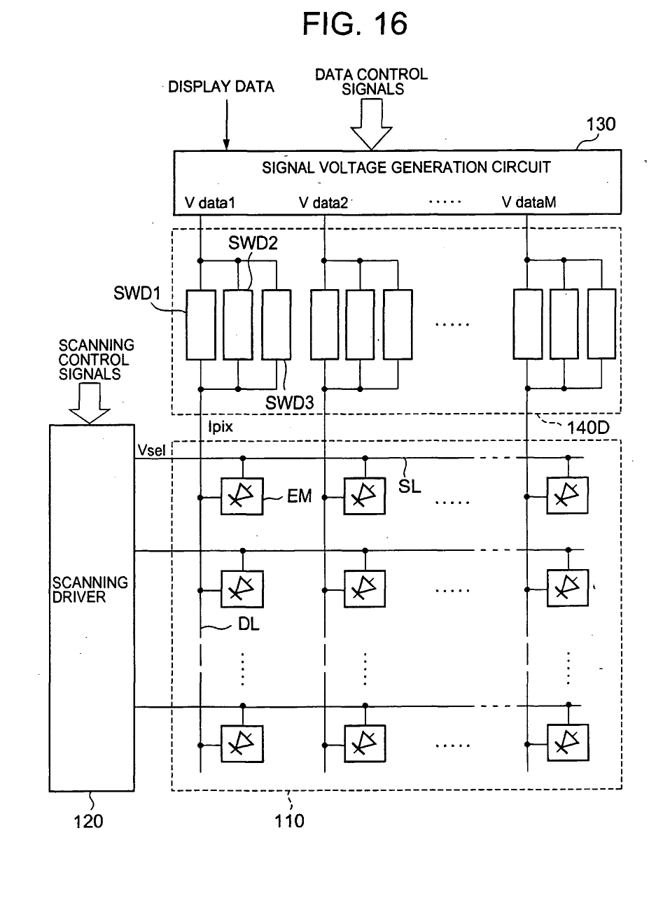

Accordingly, as shown in FIG. 15, when Nch transistor Tr34 performs an “ON” operation by a continuity condition corresponding to the signal voltage Vdata, each of the data lines DL are connected to the sync power supply voltage Vnsk (−18V) via Nch transistors Tr36, Tr34 and Tr35. Because the signal current (gradation current Ipix) has a predetermined voltage value corresponding to the signal voltage Vdata which flows in the direction of the sync power supply voltage Vsnk from the data lines DL side, the gradation current Ipix is supplied (written in) to the display pixels EM (pixel driver circuits DC mentioned above) of rows in a selection state connected to the data lines DL. Therefore, Nch transistors Tr34˜Tr36 at least constitute a write-in circuit related to the present invention.

Therefore, the switching circuit section SWC which has a configuration mentioned above to each of the data lines DL is established. In the voltage-current conversion circuit preceding the operation which supplies the gradation current Ipix corresponding to the display data to the display pixels EM set to each of the data lines DL, the voltage between gate-source of Nch transistor Tr34 of the signal data Vdata outputted from the signal voltage generation circuit 130 is converted into the gradation current Ipix. Even if the voltage between gate-source of Nch transistor Tr34 is a case where the threshold value changes with the passage (lapse) of time, etc., by establishing the precharge voltage so as to become equivalent to the threshold voltage of the Nch transistor Tr34, the threshold voltage is set at that time. Accordingly, the gradation current Ipix having a current value corresponding to the signal voltage Vdata can always be generated and supplied to the data lines DL. Also, when it is a case where the voltage-current conversion circuit (particularly the above-stated Nch transistor Tr34) is formed with the application of amorphous silicon, the effects of fluctuation in the operating characteristics (threshold voltage) can be controlled, proper gradation display can be achieved over a long period of time and a display device with superior image quality can be produced relatively cheaply.

Furthermore, in the embodiment as shown in the timing chart in FIG. 10, the set period for each of the control signals (data enable signal DEN, the auto zero signal AUZ, the set signal SET, the first pixel write-in/reset signal WR1 and the second pixel write-in/reset signal WR2) needs only to be established properly based on the switching and current characteristics of each of the Nch transistors Tr31˜Tr36 which constitute the switching circuit section SWC, the charge and discharge characteristic of the capacitors C31 and C32, a voltage value of the signal voltage Vdata, a current value of the gradation current Ipix, etc.

### Fourth Embodiment

Next, the fourth embodiment of the display device which can apply the driver apparatus related to the present invention will be explained with reference to the drawings.

FIG. 16 is an outline block diagram showing an example of the main section configuration in the fourth embodiment of the display device applied to the driver apparatus related to the present invention.

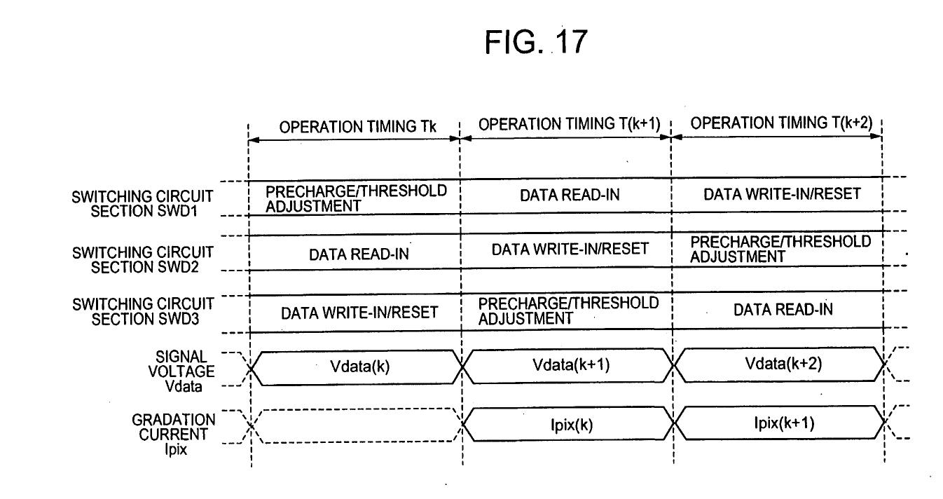

FIG. 17 is a timing chart showing the drive control operation in the voltage-current conversion circuit related to the fourth embodiment.

Here, with respect to any configuration equivalent to the third embodiment mentioned above, the same or equivalent nomenclature is appended and the explanation is simplified or omitted from the description.

Although the configuration in the third embodiment mentioned above comprises only one switching circuit section as shown in FIG. 9 for each of the data lines arranged to the display panel, the fourth embodiment has a configuration of a plurality of switching circuit sections set for each of the data lines, the drive control timing of each switching circuit section is staggered and at least the data read-in operation and the data write-in operation are executed selectively.

In the voltage-current conversion circuit 140D related to the fourth embodiment, as shown in FIG. 16, the switching circuit sections SWD1, SWD2 and SWD3 have a configuration equivalent to the third embodiment mentioned above and have a configuration of a plurality (three modules in this embodiment) set in parallel for each of the data lines DL. As the signal voltage Vdata outputted from the signal voltage generation circuit 130 is supplied selectively at different timing to any of the switching circuit sections SWD1, SWD2 and SWD3, the signal current (gradation current Ipix) generated by each of the switching sections SWD1, SWD2 and SWD3 is configured so that the data lines DL can be supplied selectively at different timing. Here, in each of the switching circuit sections SWD1, SWD2 and SWD3, the control signals (data enable signal DEN, the auto zero signal AUZ, the set signal SET, the first pixel write-in/reset signal WR1 and the second pixel write-in/reset signal WR2) which control a series of operations as described in the third embodiment above, for example, from the system controller 150 each of the switching circuit sections SWD1, SWD2 and SWD3 is individually supplied.

In the voltage-current conversion circuit which has such a configuration, for example, each of the switching circuit sections SWD1, SWD2 and SWD3 functions as a one module operation respectively for executing the precharge operation, the threshold voltage adjustment operation, the data read-in operation and the data write-in operation; each of the switching circuit sections SWD1, SWD2 and SWD3 is controlled so that module operation differs; and each of the switching circuit sections SWD1, SWD2 and SWD3 executes a series of control operations as shown in FIG. 10 and mentioned above at timing which does not overlap.

That is, as shown in FIG. 17, while executing the precharge operation and the threshold voltage adjustment operation in the switching circuit section SWD1 at operation timing Tk (operation period), in simultaneous parallel executes the data read-in operation in the switching circuit section SWD2 and executes the data write-in operation and reset operation of the next processing cycle in the switching circuit section SWD3.

Next, while executing data read-in operation in the switching circuit section SWD1 at operation timing (k+1), in simultaneous parallel executes the data write-in operation and reset operation of the next processing cycle in the switching circuit section SWD2 and executes the precharge operation and the threshold adjustment operation in the switching circuit section SWD3.

Subsequently, while executing the data write-in operation and the reset operation of the next processing cycle in the switching circuit section SWD1 at operation timing (k+2), in simultaneous parallel executes the precharge operation and the threshold voltage adjustment operation in the switching circuit section SWD2 and executes the date read-in operation in the switching circuit section SWD3.

By performing such a series of control operations repeated sequentially in simultaneous parallel to a plurality (three modules) of the switching circuit sections SWD1, SWD2 and SWD3, the signal voltage Vdata corresponding to the display data is outputted consecutively from the signal voltage generation circuit 130 and taken in sequentially by the switching circuit sections SWD1, SWD2 and SWD3. Simultaneously, the gradation current Ipix corresponding to the signal voltage Vdata taken in by previous operation timing can be consecutively outputted to the data lines DL from the switching circuit sections other than the switching circuit section which is executing take-in of this signal voltage Vdata.

Consequently, as in the third embodiment described above and as shown in FIG. 10, the gradation current Ipix can be outputted while taking in the signal voltage Vdata consecutively by performing a simultaneous parallel and complemental operation of the switching circuit sections set in a parallel plurality of modules. Even in cases where the threshold voltage adjustment operation which compensates the threshold voltage of the Nch transistor Tr34 for performing voltage-current conversion in the voltage-current conversion circuit requires a certain amount of time (namely, when the gradation current Ipix is not generated and outputted simultaneously with application of the signal voltage Vdata), the operating speed as perceived by the voltage-current conversion circuit can be elevated and the display properties of the image information can be stably maintained.

Next, the mounting configuration of the drive apparatus and the display device related to the present invention will be explained with reference to the drawings.

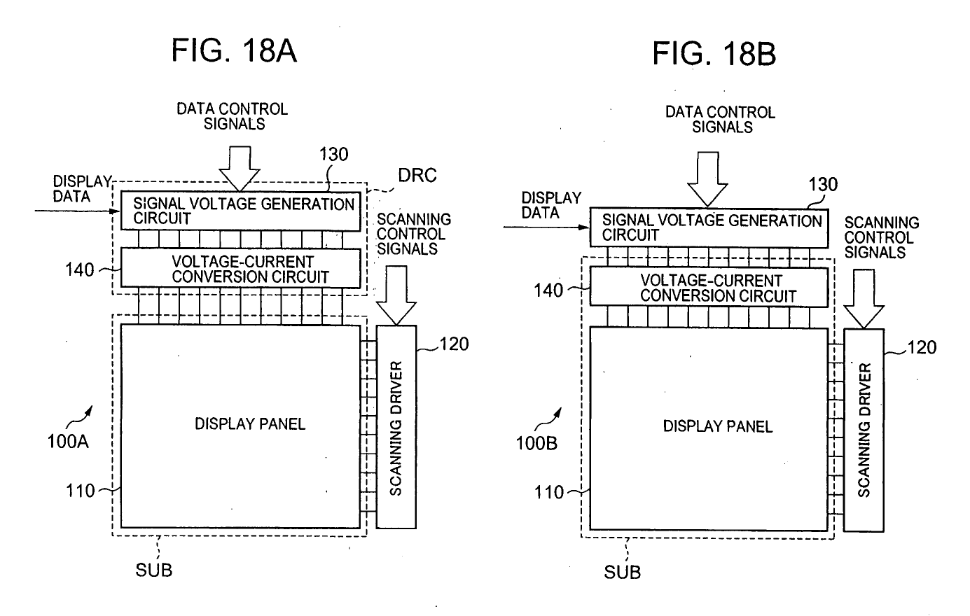

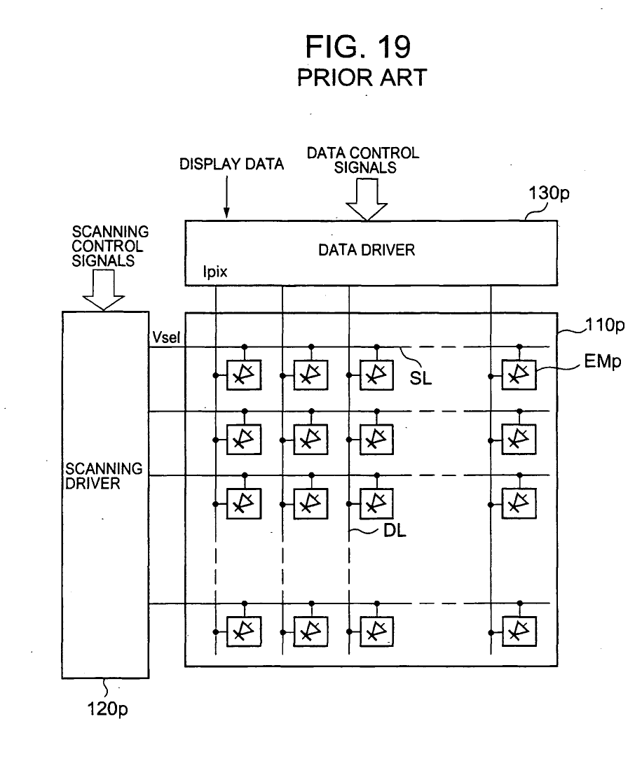

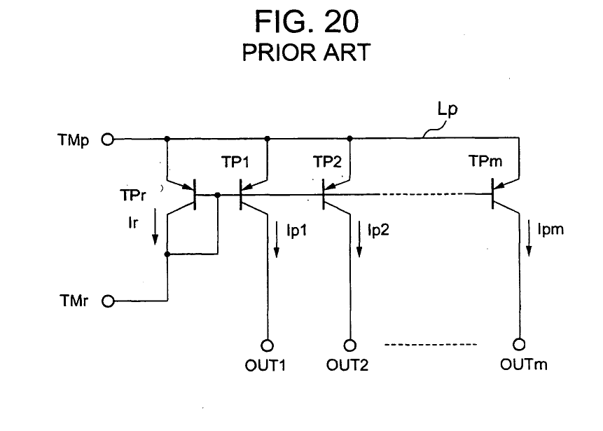

FIGS. 18A and 18B are outline block diagrams showing examples of the mounting configurations of the driver apparatus and display device related to the present invention.

Here, with respect to any configuration equivalent to the embodiments mentioned above, the same or equivalent nomenclature is appended and the explanation is simplified or omitted from the description.

In the display device shown in each embodiment above, although particular reference is not stated with respect to the mounting relationship between the display pane and its peripheral circuits (the scanning driver, the signal current generation circuit, the voltage-current conversion circuit, etc.), the mounting configuration in FIGS. 18A and 18B is applicable.

That is, in the mounting configuration of the display device 100A shown in FIG. 18A, the signal voltage generation circuit 130 and the voltage-current conversion circuit 140 are formed in one unit as the same driver chip DRC and this driver chip DRC has a configuration arranged on the boundary of the display panel 110.

In the display device 100A which has such a configuration, the driver chip DRC in which the signal voltage generation circuit 130 and the voltage-current conversion circuit 140 mentioned above are formed in one unit can be regarded as a single unit data driver (current driver). In this respect, it can be applied easily to a display panel which has a pixel structure corresponding to a current application type method without changing substantially the circuit design of an existing display device. Thus, a display device with superior gradation display and superior display image quality can be inexpensively produced.

In the mounting configuration of the display device 100B shown in FIG. 18B, the voltage-current conversion circuit 140 is formed in one unit on an insulating substrate SUB (panel substrate), such as a glass substrate in which the display panel 110 (pixel array) is formed. Further, it has a configuration in which the signal voltage generation circuit 130 is arranged on the boundary of this insulating substrate SUB.

Since a Thin-Film Transistor which uses amorphous silicon as a switching element as applied to the pixel driver circuits DC provided in the display pixels EM arranged to the display panel 110 and the voltage-current conversion circuit 140 is applicable in the display device 100B which has such a configuration as mentioned above, an already established amorphous silicon manufacturing technology can be applied and a panel module as for which an operating characteristic is stabilized can be manufactured at comparatively low cost. Further, since a general-purpose voltage driver is applicable as the signal voltage generation circuit 130 arranged on the boundary of the insulating board SUB, a display device with a superior gradation display and superior image quality can be realized cheaply without changing the design of an existing peripheral circuit substantially.

While the present invention has been described with reference to the preferred embodiments, it is intended that the invention be not limited by any of the details of the description thereof.

As this invention can be embodied in several forms without departing from the spirit of the essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are intended to be embraced by the claims.

1. A driver apparatus which drives each display pixel of a display panel having a plurality of display pixels comprising:
a signal voltage generation circuit which generates a signal voltage having a current value corresponding to the display data; and
a voltage-current conversion circuit containing at least one of a conversion circuit section which generates a signal current having a current value corresponding to the signal voltage which is generated by the signal voltage generation circuit and supplies the display pixels by converting the signal current into a gradation current.

2. The driver apparatus according to claim 1, wherein each display pixel comprises a current control type light emitting device which performs light generation operation by a luminosity gradation corresponding to the gradation current.

3. The driver apparatus according to claim 1, wherein the conversion circuit section comprises a configuration that at least includes:
a switching element which generates the signal current with one end side of the switching element current path connected to a drive power supply having a predetermined voltage value and the other end side of the current path connected to the display pixels via the data lines; and
the signal voltage is applied to the switching element control 10 terminal.

4. The driver apparatus according to claim 3, wherein the switching element is a Field-Effect type Thin-Film Transistor which uses amorphous silicon.

5. The driver apparatus according to claim 3, wherein the switching element is a Field-Effect type Thin-Film Transistor which uses polycrystalline silicon.

6. The driver apparatus according to claim 3, wherein the switching element is a transistor composed of a semiconductor whose electron mobility is lower than 50 cm²/Vs.

7. The driver apparatus according to claim 3, wherein the drive power supply polarity is set so that the gradation current will flow in the direction drawn from the display pixels side of the display panel.

8. The driver apparatus according to claim 3, wherein the drive power supply voltage value is set as a different voltage value for each luminous color corresponding to a luminous color set as the display pixels.

9. The driver apparatus according to claim 3, wherein the conversion circuit section comprises at least a compensation circuit which compensates component characteristic fluctuation in the switching element.

10. The driver apparatus according to claim 9, wherein the switching element is a Field-Effect type Thin-Film Transistor and the component characteristic is the Thin-Film Transistor threshold voltage characteristic.

11. The driver apparatus according to claim 9, wherein the compensation circuit comprises at least a precharge circuit which applies a precharge voltage corresponding to the switching element threshold voltage to the switching element control 5 terminal prior to applying the signal voltage to the switching element control terminal.

12. The driver apparatus according to claim 11, wherein the conversion circuit section further comprises:
a reset circuit which applies a reset voltage to the display pixels prior to supplying the gradation current;
a read-in circuit which applies the signal voltage to the control terminal of the switching element; and
a write-in circuit which supplies the display pixels by converting the signal current into the gradation current that flows in the switching element current path based on the precharge voltage and a sum total voltage of the signal voltage.

13. The driver apparatus according to claim 12, wherein the voltage-current conversion circuit of a plurality of the conversion circuit sections are connected in parallel and concurrently execute at least:
a read-in operation which applies the signal voltage by the read-in circuit of the switching element in the conversion circuit section to any one of the plurality of conversion circuit sections; and
a write-in operation which supplies the gradation current to the display pixels corresponding to the signal voltage applied to the switching element at previous timing by the write-in circuit in the other conversion circuit sections.

14. A display device which displays desired image information corresponding to a display data comprising:
a display panel which has a plurality of scanning lines and a plurality of data lines arranged in row and column directions, and a plurality of display pixels arranged in matrix form near each intersecting point of the plurality of scanning lines and the plurality of data lines;
a scanning driver circuit which sequentially applies a scanning signal to each row of the display pixels in the display panel at predetermined timing for setting in a selection state;
a signal voltage generation circuit which generates a signal voltage having a current value corresponding to the display data;
a voltage-current conversion circuit containing a conversion circuit section which generates a signal current having a current value corresponding to the signal voltage which is generated by the signal voltage generation circuit and supplies the display pixels by converting the signal current into a gradation current.

15. The display device according to claim 14, wherein the display panel comprises at least:
a pixel driver circuit which generates a light generation drive current having a current value corresponding to the gradation current; and
a current control type light emitting device which performs light generation operation by a luminosity gradation corresponding to the gradation current.

16. The display device according to claim 15, wherein the pixel driver circuit is constituted by including a switching element which uses amorphous silicon.

17. The display device according to claim 15, wherein the pixel driver circuit comprises at least:
a charge storage circuit which stores an electric charge accompanying the gradation current; and
a drive control circuit which generates the light generation drive current based on an electric charge stored in the charge storage circuit and supplies the light emitting devices.

18. The display device according to claim 17, wherein the display pixels are controlled so that an electric charge accompanying the gradation current is stored in the charge storage circuit in a selection period when each row of the display pixels is selected by the scanning driver circuit, and the light generation drive current generated by the drive control circuit is supplied to the light emitting devices in a non-selection period when each row of the display pixels is non-selected.

19. The display device according to claim 18, wherein the light emitting devices are set in a non-operational state during the selection period and set in an operational state during the non-selection period.

20. The display device according to claim 15, wherein the light emitting devices are organic electroluminescent devices.

21. The display device according to claim 14, wherein the voltage-current conversion circuit is formed as one unit with the signal voltage generation circuit.

22. The display device according to claim 14, wherein the voltage-current conversion circuit is formed in one unit with the display pixels on an insulating substrate which constitutes the display panel.

23. The display device according to claim 14, wherein the conversion circuit section comprises a configuration that at least includes:
a switching element which generates the signal current with one end side of the switching element current path connected to a drive power supply having a predetermined voltage value and the other end side of the current path connected to the display pixels via the data lines; and
the signal voltage is applied to the switching element control terminal.

24. The display device according to claim 23, wherein the switching element is a Field-Effect type Thin-Film Transistor which uses amorphous silicon.

25. The display device according to claim 23, wherein the switching element is a Field-Effect type Thin-Film Transistor which uses polycrystalline silicon.

26. The display device according to claim 23, wherein the switching element is a transistor composed of a semiconductor whose electron mobility is lower than 50 cm²/Vs.

27. The display device according to claim 23, wherein the drive power supply polarity is set so that the gradation current will flow in the direction drawn from the display pixels side via the data lines.

28. The display device according to claim 23, wherein each of the plurality of display pixels in the display panel are set as any luminous color of red, green, blue arranged in a predetermined order; and
the drive power supply voltage value is set as a different voltage value for each luminous color corresponding to a luminous color set as each of the display pixels.

29. The display device according to claim 19, wherein the conversion circuit section comprises at least a compensation circuit which compensates component characteristic fluctuation in the switching element.

30. The display device according to claim 29, wherein the switching element is a Field-Effect type Thin-Film Transistor and the component characteristic is the Thin-Film Transistor threshold voltage characteristic.

31. The display device according to claim 29, wherein the compensation circuit comprises at least a precharge circuit which preceding application of the signal voltage to the switching element control terminal applies a precharge voltage to the switching element control terminal corresponding to the switching element threshold voltage.

32. The display device according to claim 31, wherein the conversion circuit section further comprises:
a reset circuit which applies a reset voltage to the data lines prior to supplying the gradation current;
a read-in circuit which applies the signal voltage to the control terminal of the switching element;
a write-in circuit which supplies the display pixels via the data lines by converting the signal current into the gradation current that flows in the switching element current path based on the precharge voltage and a sum total voltage of the signal voltage.

33. The display device according to claim 32, wherein the voltage-current conversion circuit a plurality of the conversion circuit sections are connected in parallel for each of the data lines and concurrently execute at least:
a read-in operation which applies the signal voltage by the read-in circuit of the switching element in the conversion circuit sections to any one of the plurality of conversion circuit sections; and
a write-in operation which supplies the gradation current to the data lines corresponding to the signal voltage applied to the switching element at previous timing by the write-in circuit in the other conversion circuit sections.

34. A drive control method for a display device which displays desired image information comprising a display panel which has a plurality of display pixels arranged in matrix form near each intersecting point of a plurality of scanning lines and a plurality of data lines;
the display pixels are driven at least by:
sequentially applying a scanning signal to each row of the display pixels in the display panel at predetermined timing for setting in a selection state,
generating a signal voltage having a current value corresponding to the display data, and
by applying the signal voltage to a switching element control terminal for use in voltage-current conversion, a signal current having a current value corresponding to the signal voltage which flows in the switching element current path and the signal current is supplied as a gradation current via the data lines to the display pixels of rows set in the selection state.

35. The drive control method for a display device according to claim 34, wherein the switching element is a transistor composed of a semiconductor whose electron mobility is lower than 50 cm²/Vs.

36. The drive control method for a display device according to claim 34, wherein the switching element includes a process step which compensates component characteristic fluctuation prior to applying the signal voltage to the switching element.

37. The drive control method for a display device according to claim 36, wherein the switching element is a Field-Effect type Thin-Film Transistor and the component characteristic is the Thin-Film Transistor threshold voltage characteristic.

38. The drive control method for a display device according to claim 36, wherein the switching element process step which compensates the component characteristic fluctuation includes a process step which at least applies a precharge voltage corresponding to the switching element threshold voltage to the switching element control terminal prior to applying the signal voltage to the switching element control terminal.

39. The drive control method for a display device according to claim 34, wherein the process step which supplies the gradation current to the display pixels via the data lines includes process steps of:
applying a reset voltage to the data lines prior to supplying the gradation current,
applying the signal voltage to the control terminal of the switching element, and
the signal current which flows in the switching element path is supplied to the display pixels via the data lines as the gradation current based on the precharge voltage and a sum total voltage of the signal voltage.
